(19) United States
(12) Patent Application Publication
(10) Pub. No.: US 2002/0133378 A1
(43) Pub. Date: Sep. 19, 2002

(54) System and method of integrated calorie management

(76) Inventors: James R. Mault, Evergreen, CO (US); John Sanderson, Bainbridge Island, WA (US); Nicholas Anderson, Seattle, WA (US); Rob Pledger, Lake Oswego, OR (US)

Correspondence Address: GIFFORD, KRASS, GROH, SPRINKLE,, ANDERSON & CITKOWSKI, P.C., Suite 400, 280 N. Old Woodward, Birmingham, MI, 48009, US

(21) Appl. No.: 09/976,967

(22) Filed: Oct. 12, 2001

Related U.S. Application Data
(60) Provisional application No. 60/240,185, filed on Oct. 13, 2000.

(51) Int. Cl. G06F 17/60

(52) U.S. Cl. 705/3

(57) ABSTRACT

A system and method of integrated calorie management is presented. The system includes a computer with a processor, memory, display and user input mechanism. The method includes the steps of measuring a resting metabolic rate (RM) of a user and utilizing the measured resting metabolic rate and user activity level over a predetermined time interval to determine a total energy expenditure (TEE) of the user. The method also includes the steps of determining a total calorie intake (TCI) value representing the person's total calorie intake during the predetermined time interval and determining a caloric balance (CB) for the user from the total energy expenditure measurement and the total calorie intake value. The method further includes the step of using a rate of change of the measured resting metabolic rate to determine when to remeasure the resting metabolic rate of the user.

### RELATED APPLICATION

The present application is related to provisional application No. 60/240,185, filed Oct. 13, 2000, hereby incorporated by reference, and claims the priority date of that application.

### FIELD OF THE INVENTION

The present invention relates to a system and method of health management, and in particular to a system and method of integrated calorie management.

### BACKGROUND OF THE INVENTION

Good health and weight control are of considerable interest to a large number of people. Many people engage in conventional weight loss schemes, usually based on a restricted calorie diet. Physical activity may be included in a calorie management system of a weight control program.

A calorie management system allows a person to compare caloric expenditure, comprising resting metabolic rate (RMR) and activity-related caloric expenditure, to his or her caloric intake in the form of food and beverages. Caloric expenditure has two components: a larger component related to resting metabolic processes, and a smaller component related to the energy expended in physical activity. Total energy expenditure (TEE) is the sum of resting energy expenditure (REE, a product of resting metabolic rate and the time period of interest), and activity-related energy expenditure (AEE); that is:

TEE=REE+AEE

Calorie balance is defined in terms of the difference between TEE and the caloric intake of the person.

There is a serious inadequacy in conventional weight management programs. The RMR of a person changes unpredictably during the progress of as a weight management program directed to weight reduction. A typical weight loss program involves reduction in caloric intake. This reduction in caloric intake can cause the body to respond by invoking various protection mechanisms that would be implemented in a starvation scenario, such as causing a significant drop in RMR over time in an effort to adjust to the reduced intake of calories. As a consequence, the variables in the calorie balance equation change over time as well. In fact, a person may even gain weight on a reduced calorie diet if RMR drops to a level sufficient to offset the impact of the intake calorie reduction. Under such circumstances, a diet can actually have little or no weight loss benefit, and may even result in unintended weight gain, frustrating the dieter and jeopardizing diet compliance.

Alternatively, some people may experience no fall in metabolic rate during a restricted calorie diet, or may actually experience an increase in RMR. If the weight management program contains an exercise component, the resting metabolic rate of a person may increase during the program as a result of the exercise.

The Harris-Benedict equation, as is understood in the art, is used to estimate RMR, and predicts that resting metabolism will fall as body weight is lost. However, it is not capable of predicting the actual changes in a person's resting metabolic rate as a response to any of the wide varieties of weight management programs. Providing only an estimate of the resting metabolic rate of a person using an equation will likely lead to significant errors in calculating the actual caloric needs and activity levels required for an effective weight management program.

RMR can be determined using an indirect calorimeter. Conventional indirect calorimeter devices are large, expensive, complex, and so difficult to use that expert assistance is essential. Examples of conventional indirect calorimeters, commonly referred to as “metabolic carts,” include the currently commercially available Medgraphics CPX device, and the Sensormedics VMAX Series devices. Because of the significant size and cost of these devices, access is predictably limited to specialty applications. A person typically will need to report to a specific location, such as a hospital or other health care facility, for access to and use of these conventional indirect calorimeter devices. Because of this considerable difficulty and expense associated with conventional indirect calorimeter use, conventional weight management programs do not monitor the RMR of the person in the program, but rather rely on an estimate such as provided by the Harris-Benedict equation, the deficiencies of which have been expressed previously.

In U.S. Pat. No. 5,704,350, Williams describes a nutritional microcomputer and method of use in a weight control program. A hand-held device is described which enables a log of diet to be recorded, activity levels to be recorded, and diet goals to be set. The Harris-Benedict equation is used to estimate the user's daily caloric expenditure. Hence, this device and method fail to take into account the change in RMR at the onset of a diet.

In U.S. Pat. No. 5,673,691, Abrams et al. describe an apparatus to manage or control weight, in which caloric intake levels are adjusted on the basis of changes in the user's body weight. The actual metabolic rate of the user is not determined in the described method of using this device.

In U.S. Pat. No. 4,951,197, Mellinger describes a diet method in which estimated caloric expenditure is calculated from the weight of the person. Individual variations in RMR, and RMR changes during a diet, are not taken into account.

In U.S. Pat. No. 5,890,128, Diaz et al. describe a hand-held calorie computer for use in a weight management program. For weight loss, caloric intake is decreased gradually so as to hopefully avoid abrupt changes in the user's metabolic rate. The gradual caloric reduction regime limits the flexibility of selecting among the wide variety of diet plans and food recipes available, and also limits the selectivity of pace of the weight reduction. More importantly, this approach is not as effective as actually measuring the user's metabolic rate and compensating for any changes, as described in embodiments of the present invention.

In U.S. Pat. No. 5,705,735, Acorn describes monitoring the oxygen consumption and carbon dioxide production of a patient using a bulky and inconvenient ventilator device, and using the resulting data to assess nutritional requirements. The ventilator device is configured for use by a health care professional and requires skilled extraction of the data for the application described. This apparatus is not adapted to provide information directly to the patient, but rather to the health professional in attendance, and therefore suffers from lack of convenience and ease of use in a weight control program.

In U.S. Pat. No. 5,989,188, Birkhoelzer et al. describe the use of indirect calorimetrics in determining the energy balance of a living subject. However, Birkhoelzer et al. do not envision the problematical effects of metabolic change caused by a weight control program on predicting the outcome of the weight control program. They do not describe a weight control program in which the RMR of the subject is monitored through the course of the program, and do not describe how changes in RMR may be used to modify the recommended caloric intake, activity levels, and/or target goals of a weight control program.

In U.S. Pat. No. 5,839,901, Karkanen describes a weight loss method, in which a computing device is used to present data in a tabular form to a user concerning weight loss trends, food calories, activity calories expended, calculated ending weight, and other diet-related parameters. However, there is no presentation of calorie management data according to the success or failure of the program.

In U.S. Pat. No. 5,913,310, Brown uses the representation of a plane disappearing behind a cloud to indicate data uncertainty within a blood glucose management system. However, this representation is unrelated to calorie management data, and the cloud symbol is not chosen according to progress towards a goal.

In U.S. Pat. No. 5,989,188, Birkhoelzer et al. describe a method of determining energy balance of a person, in which red and green displays may be shown to a user depending on the energy balance of the user.

In U.S. Pat. No. 6,095,949, Arai describes a diet calculator and activity monitor, which uses animated icons on a liquid crystal display to suggest the future consequences of a diet program. The icons chosen indicate thin, normal, or corpulent figures according to projected diet success. These icons may not be acceptable to a dieter, due to harmful psychological effects.

In co-pending U.S. patent application Ser. No. 09/685,625, which is incorporated herein by reference, the RMR of an individual is used to suggest a calorie intake level and activity level for use in a weight management program. RMR is measured using an indirect calorimeter, as described in co-pending U.S. patent application Ser. No. 09/630,398, which is incorporated herein by reference.

Thus, there is a need in the art for a system and method of weight management that measures the resting metabolic rate (RMR) of a user at relatively short intervals and modifies the RMR component of caloric balance used in the calorie management software on a dynamic basis to compensate for changes in metabolism which occur during weight control.

### BRIEF SUMMARY OF THE INVENTION

Accordingly, the present invention is a method of assisting a person in a weight control program to extend over a predetermined time period, by dividing a predetermined time period into a plurality of time intervals; recording in each of the time intervals a total calorie intake (TCI) value representing the person's total calorie intake during the respective time interval; measuring the resting metabolism (RM) of the person during the respective time interval; utilizing the measured resting metabolism to produce a measurement of the total energy expenditure (TEE) of the person during the respective time interval; computing from the total energy expenditure measurement and the total calorie intake value a caloric balance (CB) value; and varying the length of successive time intervals inversely to the change in the measured resting metabolism in one time interval with respect to that in the preceding time interval to thereby reduce errors caused by changes in the resting metabolism during the successive time intervals.

One advantage of the present invention is that an indirect calorimeter is used to monitor the RMR of a person at each time interval. The indirect calorimeter allows direct measurement of a person's RMR at intervals to correct for a person's metabolism changes occurring as a result of diet. RMR changes may be accurately tracked over the course of a weight loss program. RMR may be measured at more frequent intervals (for example, once every 1-5 days) at the start of a weight control program, when metabolism changes may be more rapid. The measurement intervals may be lengthened (for example to once every 1-4 weeks) if the person's RMR settles down to an approximately constant value in the course of a weight control program.

Another advantage of the present invention is that the method presents progress made by a person towards a goal, the progress being characterized by a parameter. The method establishes a target value of the parameter to serve as a goal for the person to achieve, determines an actual value of the parameter achieved by the person and compares the actual value with the target value, and presents to the person calorie balance information.

Still another advantage of the present invention is that a system is provided for assisting a person in a weight control program to extend over a predetermined time period constituted of a plurality of time intervals. The system includes: a computer device having a data entry mechanism, a processor, a memory, a display, and software downloadable to control the computer device; to record a target goal to be achieved during the predetermined time interval; to record in each of the time intervals a total calorie intake (TCI) value representing the person's total calorie intake during the respective time interval; to record in each of the time intervals a total energy expenditure (TEE) value representing the total energy expenditure of the person during the respective time interval; to compute from the total energy expenditure value and the total calorie intake value a calorie balance (CB) value for the respective time interval; and to display a graphical indication of whether the calorie balance value computed for the respective time interval is progressing favorably or unfavorably for achieving the target goal.

A further advantage of the present invention is that the system and method assist a person in achieving a weight control target goal, such as weight loss, weight gain, or weight maintenance. The method is preferably adapted to receive calorie management data, such as body weight, body fat, metabolic rate, activity data, calories consumed, and other parameters affecting the calorie balance of the person.

For example, a person may be assisted towards a weight loss goal to be achieved during a predetermined time period, such as several weeks or months. The person is provided with a software program adapted to run on a portable computing device, such as a personal digital assistant (PDA). According to the software program, the computing device receives from the person calorie management data at periodic time intervals, such as each day. The software program assists the person in establishing a target value caloric balance for each such time interval, e.g. each day or plurality of days. An acceptable degree of progress towards the weight control goal is made if the target calorie balance value is achieved by the person. The acceptable degree of progress may be one under which the person achieves a specified weight loss at a specified rate or after a specified time. The software determines the actual value of the calorie balance for each day by calorie management data being entered by the person into the computing device, or data received from other devices or systems in communication with the computing device. The software program compares the actual value of calorie balance with the target value of calorie balance, and displays a graphic representation or icon to illustrate the progress made towards the weight loss goal. In a preferred embodiment, the graphic display is weather-related and represents good weather if an acceptable degree of progress is made.

Still a further advantage of the invention is that a balance log method of displaying the progress made during a weight control program to extend over a predetermined period, e.g., several months is provided. The display includes both the calorie balance for the person over an interval of this period, e.g. a day, and the cumulative calorie balance for the person since the start of the weight control program. The display of the computing device is used to show a first icon if the calorie balance for the day is favorable and the cumulative calorie balance is favorable, a second icon if the calorie balance for the day is favorable and the cumulative calorie balance is unfavorable, a third icon if the calorie balance for the day is unfavorable, and the cumulative calorie balance is favorable, and a fourth icon if the calorie balance for the day is unfavorable and the cumulative calorie balance is unfavorable. The fourth icon is preferably representative of stormy weather, and the first icon is preferably representative of sunny weather. The second and third icons may be chosen to convey a mixed message, such as bad weather clearing to good, or vice versa.

Other features and advantages of the invention will be readily appreciated, as the same becomes better understood, after reading the subsequent description taken in conjunction with the accompanying drawings.

### BRIEF DESCRIPTION OF THE DRAWINGS

FIG. 1A is a block diagram illustrating a system in accordance with the present invention of integrated calorie management;

FIG. 1B is a flow chart of a method of integrated calorie management using the system of FIG. 1, according to the present invention;

FIGS. 2A-2D illustrate examples of screen displays presented to the user during the setup procedure, according to the present invention;

FIGS. 3A-3L illustrate examples of screen displays presented to the user with information for the user, according to the present invention;

FIGS. 4A-4B illustrate examples of a screen for entering in the resting metabolic rate into the computing device, according to the present invention;

FIGS. 5A-5B illustrate examples of a food entry screen, according to the present invention;

FIGS. 6A-6B illustrate examples of an exercise entry screen, according to the present invention;

FIGS. 7A-7B illustrate a daily calorie balance screen, according to the present invention;

FIGS. 8A-8C illustrate a calorie balance summary, according to the present invention;

FIG. 9 is a block diagram illustrating another system in accordance with the present invention; and

FIGS. 10A-22 illustrate a method of integrated calorie management in the form of screens presented on a portable computing device, using the system of FIG. 9, according to the present invention.

### DETAILED DESCRIPTION OF THE INVENTION

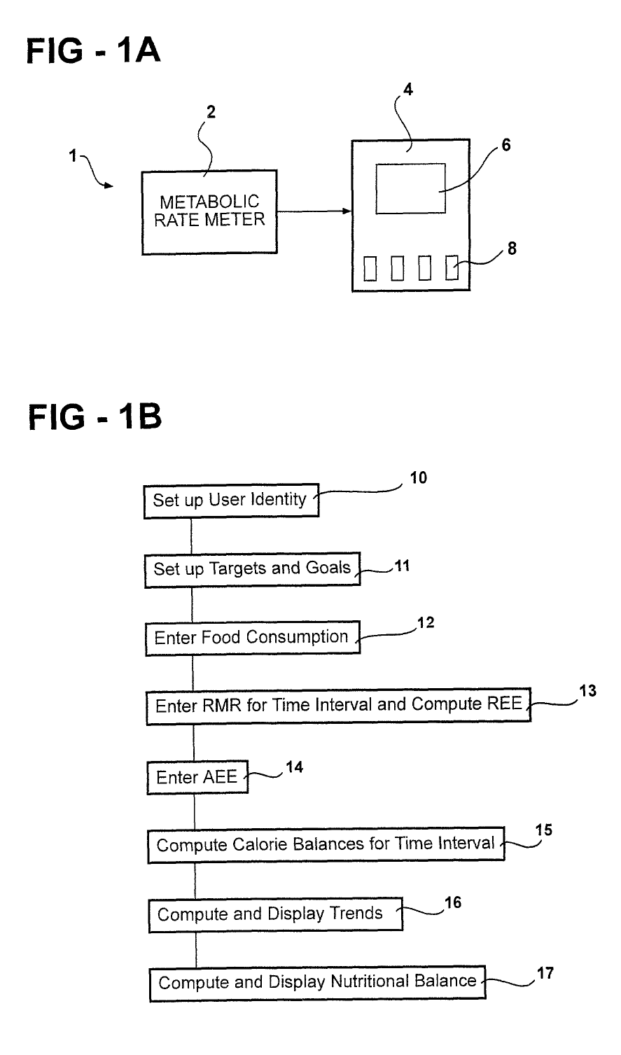

FIG. 1A shows a system 1 in accordance with the present invention for use by a person (not shown) as part of an integrated calorie management program. In this example, the weight control program is a weight control program for achieving a target weight. A device 2 for the measurement of metabolic rate (a metabolic rate meter) provides metabolic rate data relating to the user at intervals to a computing device 4. Preferably, an indirect calorimeter (such as that described in U.S. application Ser. No. 09/630,398) provides RMR measurements of the user to computing device 4. Computing device 4 has a display 6 and data entry buttons 8. Preferably, computing device 4 is a personal digital assistant (PDA), but may be any electronic device having some computer capability, such as a portable computer; electronic organizer; e-book; wireless phone; pager; wristwatch with added computer functionality; other electronic system having separate display, entry, and computing modules; any portable/wearable device, such as a pedometer, having added computing functionality; or a desktop computer system.

The computing device 4 receives predetermined health related information on a periodic basis, such as daily. This information includes the metabolic rate data, caloric intake data relating to diet, and physical activity level data, for the respective period. The computing device 4 also receives data concerning goals desired to be achieved in a predetermined time period, such as several weeks or months, and provides continuous feedbacks to the user with respect to these weight goals. These feedbacks are modified by changing values in the metabolic rate of the user. While diet logging software and activity monitors are known in the art, conventional weight control methods do not compensate for changes in the metabolic rate of the user, as in this embodiment of the invention.

Referring to FIG. 1B, a method of integrated calorie management, according to one embodiment of the invention, is illustrated, for use with the system 1, previously described. In this example, the integrated calorie management program is used for weight management of the user. It should be appreciated that the user may implement the steps in the order shown, or in another preferred order in executing the method. In block 10, the methodology includes the step of setting up a user identity by entering name and other information in the computing device 4. In block 11 the user setting targets and goals based on information gathered from the user during an initial setup process. Examples of targets and goals include weight goals, nutrient targets, health goals, and activity plans. In block 12, the user entering food consumption through a food log with a search capability. In block 13, the user entering their residual metabolism rate (RMR) over a predetermined time interval, such as a day or several days, as will be described more particularly below and using that entry for computing the resting energy expenditure (REE). In block 14, the user enters activity information into the computing device. Preferably, a search tool or data from an activity sensor provide this information. In block 15, the methodology computes the calorie balance for a predetermined time interval, in a manner to be described. In block 16, the methodology provides information to the user, such as by reporting on body measurement trends using graphical display capabilities of the computing device or other device. In block 17, the methodology includes the step of providing feedback to the user regarding the calorie balance and time dependent logging of body measurements such as resting metabolism, body weight, and body fat percentage, and reporting on the nutritional balance of food intake.

It should be appreciated that the weight management program may be set for a predetermined time period, such as for several weeks or several months; but the RMR is measured at smaller intervals during this predetermined time period, since the person's metabolism changes over time as a result of many factors, including diet. The length of each interval between RMR measurement varies inversely to the change in the measured RMR over the measured RMR determined in the immediately preceding time interval. This reduces errors caused by changes in the RMR during the successive time intervals of the program period. For example, at the start of the weight control program, when metabolism changes may be more rapid, the measurement intervals would be relatively short, such as once every 1-5 days; but would be lengthened (such as once each week or several weeks) during the course of the program when the person's RMR settles down to a more constant value.

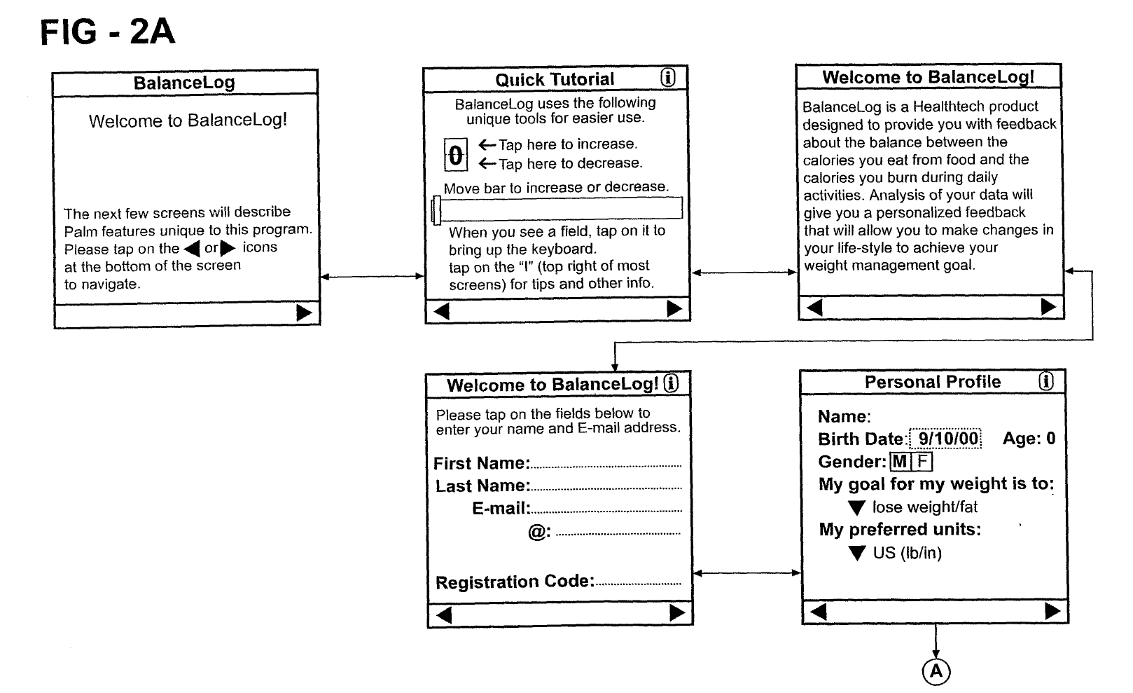

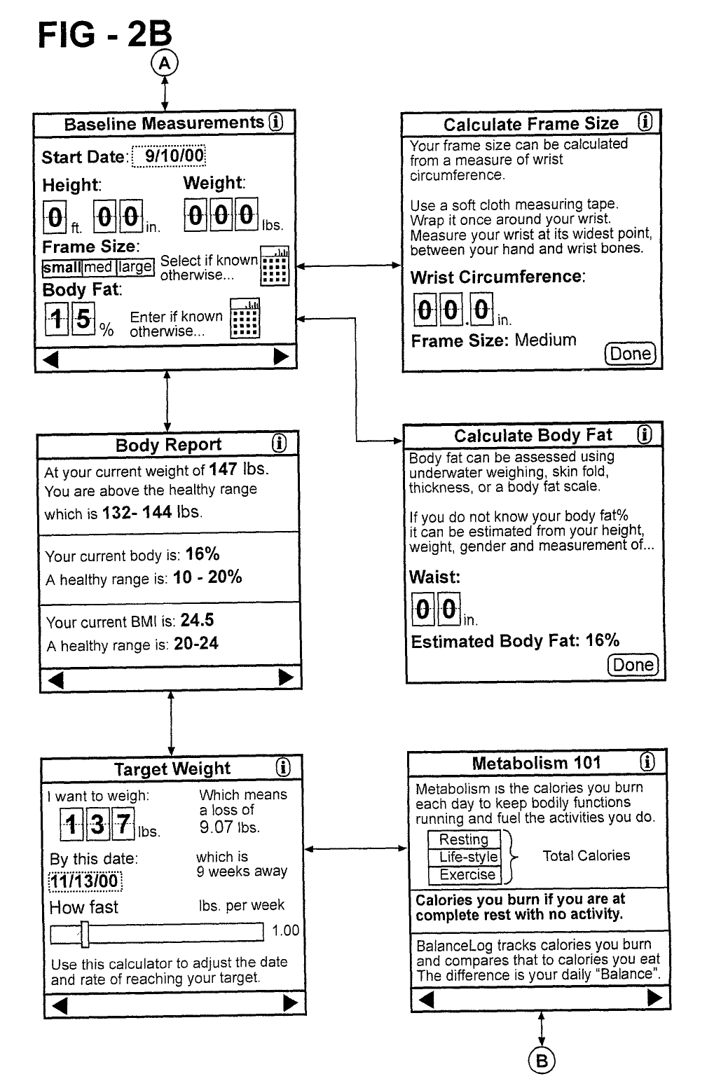

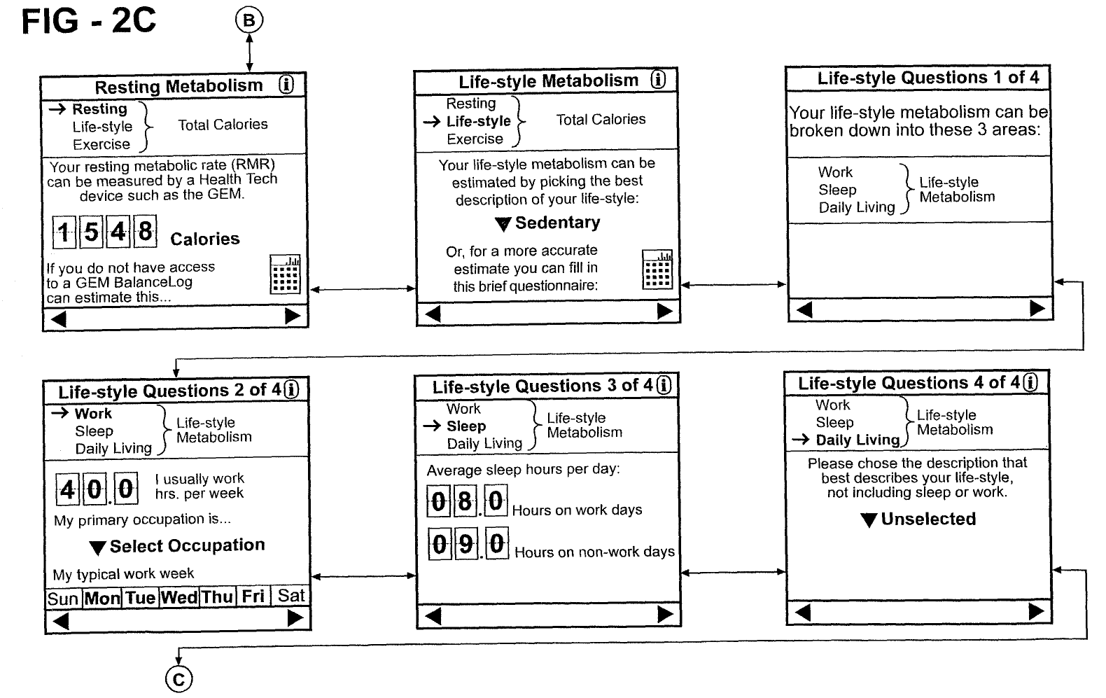

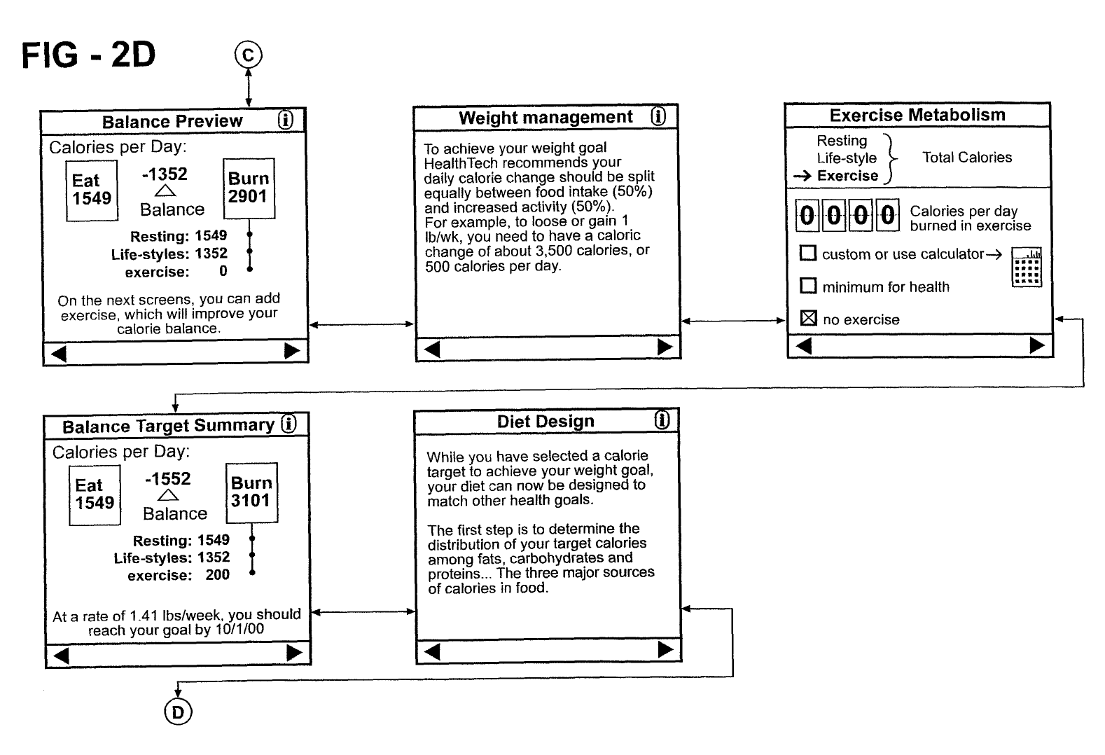

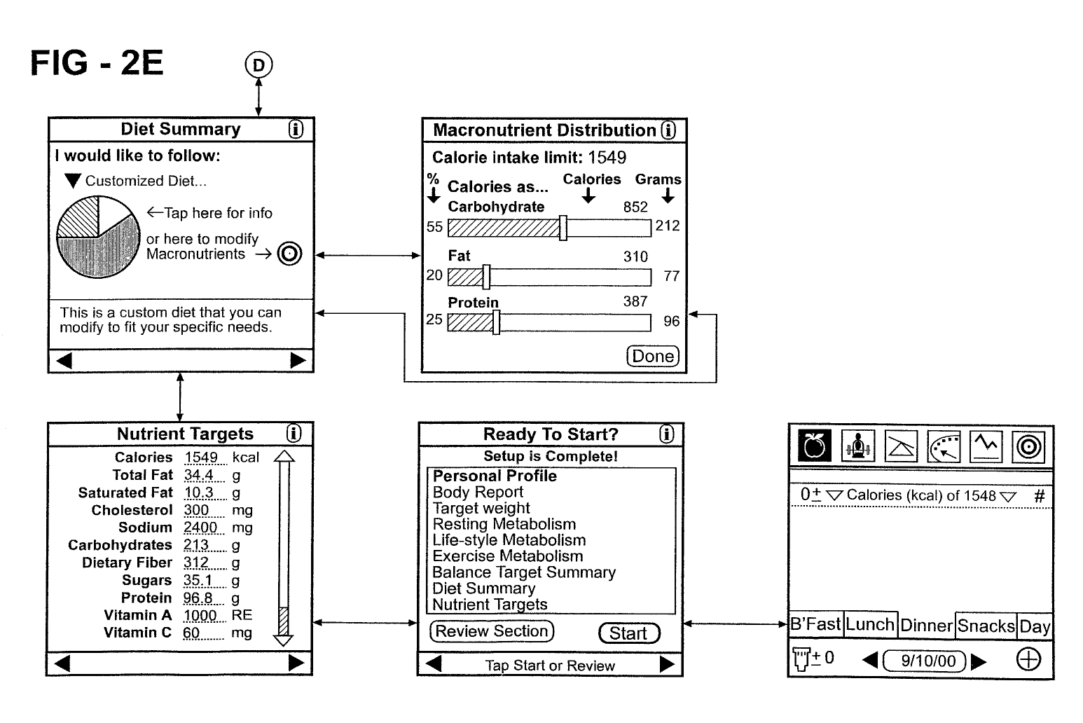

FIGS. 2A-2D show a schematic illustration of the steps 10,11 of setting up a user identity and setting targets and goals. Preferably, the methodology uses a computing device 4, such as a PalmPilot. However, the general approach may be used on any PDA or other computing device. The user enters identity, birth data, gender, along with other parameters, as shown in FIG. 2A. The method provides for an estimation of caloric expenditures as shown in FIG. 2B, for the purpose of goal setting. Preferably, a GEM (Gas Exchange Monitor), such as the indirect calorimeter described in U.S. application Ser. No. 09/630,398, is used to measure actual metabolic rates. Other indirect calorimeters may be provided for RMR measurement, and also for activity-related energy expenditure measurements. For example, a GEM may be provided to measure actual caloric expenditure in typical activities during the day. The methodology generates a balance preview (FIG. 2C), and assists the user in diet design to reach goals. Nutrient targets are displayed, a review option is presented, and the set-up is complete (FIG. 2D).

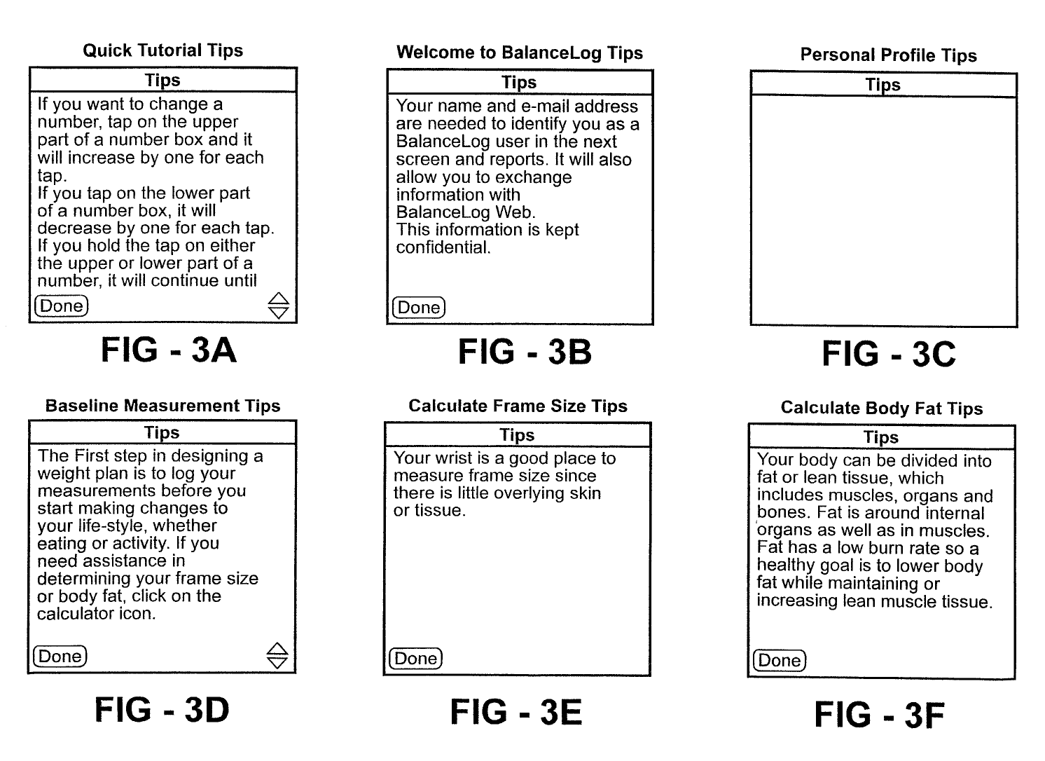

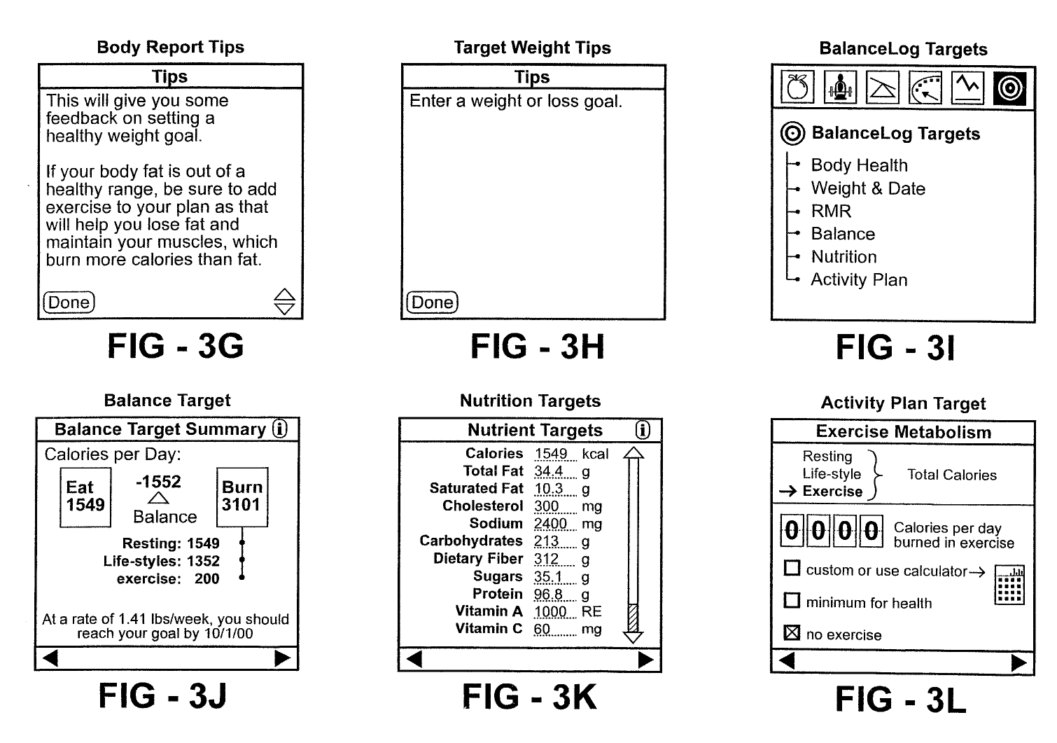

It should be appreciated that the methodology presents the user with tips regarding weight management. Preferably, these tips are presented as screens or pages on the computing device 4, as shown in FIGS. 3A-3H. Examples of tips include advice on using the system and the like. It should also be appreciated that the user may select from a menu of options relating to weight management, such as health, weight, weight loss rate, RMR, calorie balance, nutrition, and/or activity plan targets, as shown in FIGS. 3I-3L.

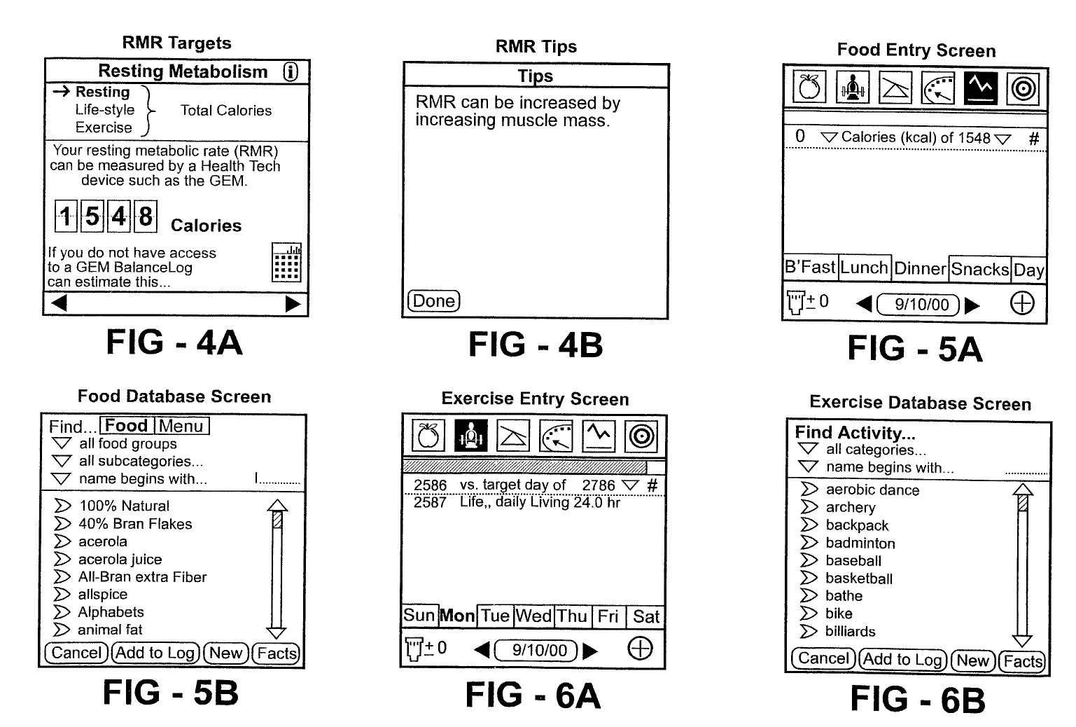

FIGS. 4A-4B schematically illustrate the step 13 of entering in the RMR for a predetermined time interval and using RMR to calculate the resting energy expenditure (REE) of the user. Preferably, the GEM or other indirect calorimeter is used to determine the user's RMR at intervals. The determined RMR is then entered into the computing device 4.

The RMR is preferably measured at intervals through the course of an integrated calorie management program such as the weight management program of this example. Advantageously, a new calculation of calorie balance, allowed caloric intake, and nutrition information is determined by the methodology for each interval. If the RMR changes significantly, final weight, weight loss rates, activity levels, and caloric intake levels may be revised to facilitate a successful outcome of the weight management program. This is to be distinguished from conventional weight management programs which do not allow these modifications during the course of a weight control program.

For example, suppose the RMR falls 10% during the first week of a weight control program for losing weight. RMR is usually a much larger component than the activity-related energy to the total caloric expenditure. Therefore, even if caloric intake is reduced 10% for the weight control program, there may be a very slow weight loss, perhaps not measurable during the first few weeks, due to the fall in RMR. In a conventional weight loss program, this would lead to discouragement and perhaps abandonment of the program. However, the present improved weight loss program allows weight loss rate goals to be revised, caloric intake to be reduced further, or activity levels to be increased as appropriate, not only to allow the initial goals to be reached, but to reinforce the user and thereby to encourage continuation of the program. Increased physical activity may be particularly important in this case, to produce an increased RMR or AEE.

In a weight control program with significant activity levels, RMR may for example increase 10%. This is a significant help to long term weight control, as an increase in RMR will lead to weight loss even if caloric intake is unchanged. However, increased muscle mass may lead to body weight remaining constant. In a conventional weight control program, this failure to lose weight will be seen as a disappointment and lead to discouragement. However, in the current improved scheme, the major achievement of increasing RMR is clearly indicated. For long term health, the present improved method allows increased RMR to be a goal of a long term weight management program, which has not previously been possible to monitor progress to this goal without expensive or difficult equipment.

Referring to FIGS. 5A-5B, the step 12 of inputting food consumption into a database in the computing device 4 is illustrated schematically. Preferably, the user selects the food entry icon from the menu of options displayed on the screen of the computing device 4. The user is presented a screen with food entry options. In FIG. 5B, a food database screen is illustrated, allowing food items to be entered either by using a menu-based system, or by entering sufficient characters to uniquely identify the food item.

Referring to FIGS. 6A-6B, the step 14 of the user inputting activity information into the computing device 4 is illustrated schematically. For example, FIG. 6A shows an exercise entry screen, allowing activities to be entered for the current day or previous days, or planned for future days. FIG. 6B shows an exercise database screen, allowing exercise and other activities to be entered either by using a menu-based system, or by entering sufficient characters to uniquely identify the activity.

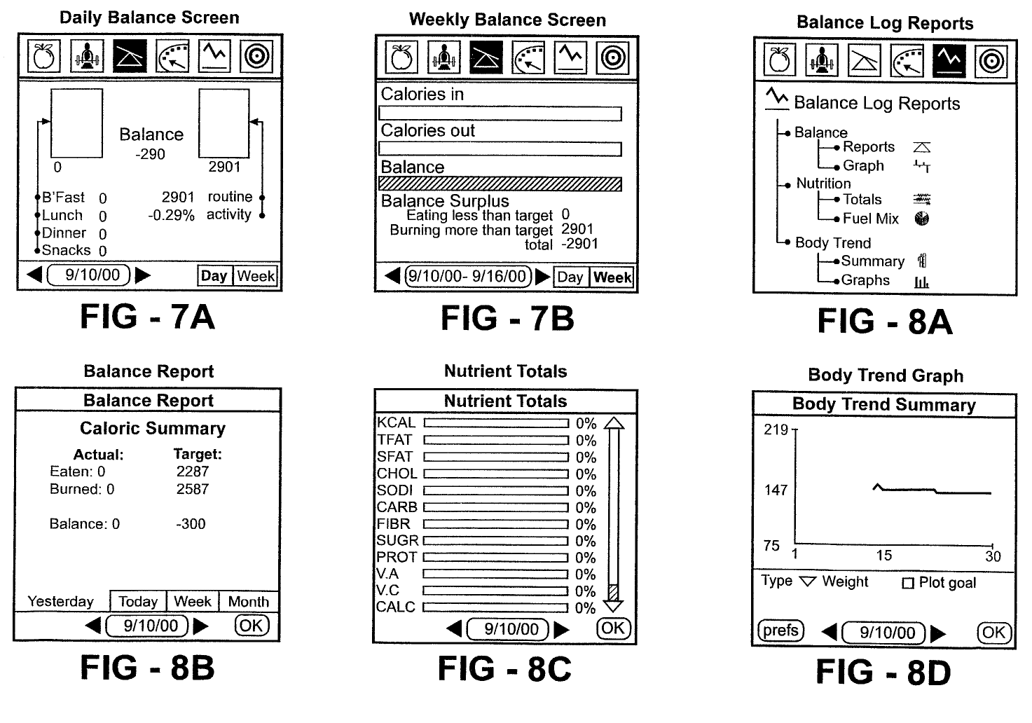

Referring to FIGS. 7A-7B, the step 15 of the methodology computing the calorie balance for the time interval is illustrated. For example, a daily balance screen is presented to the user. Advantageously, the calorie balance can be determined on a periodic basis, such as weekly.

Referring to FIGS. 8A-8C, the steps 16,17 of the methodology presenting the user with a summary of the calorie balance and nutritional is illustrated. For example, in FIG. 8A a menu screen is provided on the computing device 4 from which reports are chosen. FIG. 8B illustrates how calorie balance information can be presented graphically, and FIG. 8C illustrates nutrition information graphically. FIG. 8D shows body trends graphically.

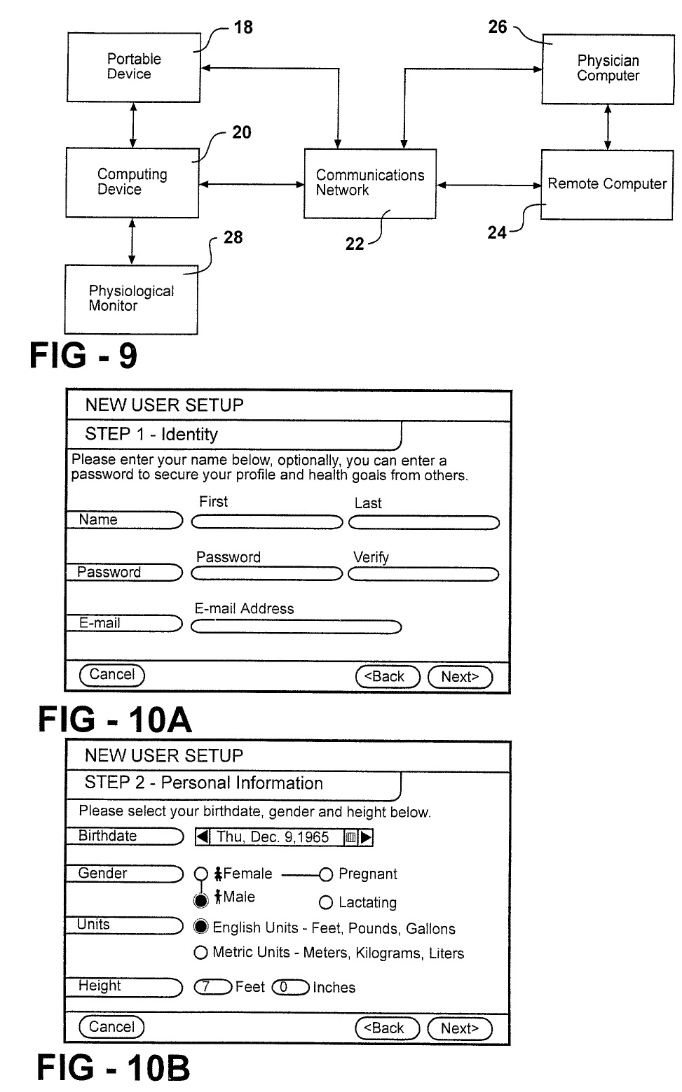

FIG. 9 shows another system 16 in accordance with the invention suitable for use in an integrated calorie management program, for example a weight loss program. The person using the system 16 uses a portable device 18 and interacts with a computing device 20. Computing device 20 is connected to a communications network 22 allowing communication with a remote computer (e.g., a server system) 24. A physician's computer 26 may also be connected to the communications network 22. The person's portable device 18 may be used for recording diet and activity related data, which communicates with computing device 20 at intervals. The person also carries a personal sensor 28 which monitors physiological parameters and/or activity related data.

In a preferred embodiment, computing device 20 is a conventional desktop personal computer system. Portable device 18 is preferably a handheld portable computer, such as a personal digital assistant (PDA) which communicates with computing device 20 at intervals, for example using a docking port interfaced to computing device 20. Data can then be synchronized between the portable device 18 and computing device 20. Data can also be synchronized at intervals between devices connected to the communications network 30. The physiological sensor 28 is preferably an activity sensor, providing a signal correlated with physical activity of the person.

In other embodiments, the portable device 18 may further comprise the functionality of a global positioning sensor, a wireless phone, a barcode reader, a physical activity monitor, a physiological monitor, some combination of the above functionalities, or some other functionality or combination of functionalities.

In a preferred embodiment, a method of integrated calorie management is implemented by the system 16, and in particular the computing device 20. The method assists the user in achieving health related goals using a balance log. In the preferred embodiments described below, the goals are related to weight loss, but could be other weight control goals, such as weight gain or weight maintenance, as described more particularly below.

The balance log weight management program methodology prompts the user to provide predetermined information. For example, in FIG. 10A the user enters his or her name, a password, and an e-mail address into the appropriate form areas of the screen of the portable device 18. In FIG. 10B, a personal information screen, such as date of birth, gender, preferred unit system (imperial or metric units), and height are entered.

Other information includes starting measures, such as the start date of the weight control program (start of plan), his or her frame size (the default is medium frame size), current weight, and body fat percentage. Body fat percentage can be determined by bioimpedance measurements, measurements of waist or hip size, by the use of equations, or may otherwise be estimated from physical properties of the person. Such estimation methods are known in the art, for example as described in European Patent Applications EP 1-055396-A2 and EP-1-063-500-A2 assigned to Tanita Corp., incorporated herein by reference.

Still other information includes lifestyle information, such as the user's typical exercise and sport level, work hours, etc. Further examples of information includes details of the user's lifestyle, including sleep hours per day, job description, and a qualitative estimate of the physical activity involved in the user's job. A slider control 90 may be provided to enter the appropriate activity level of the job.

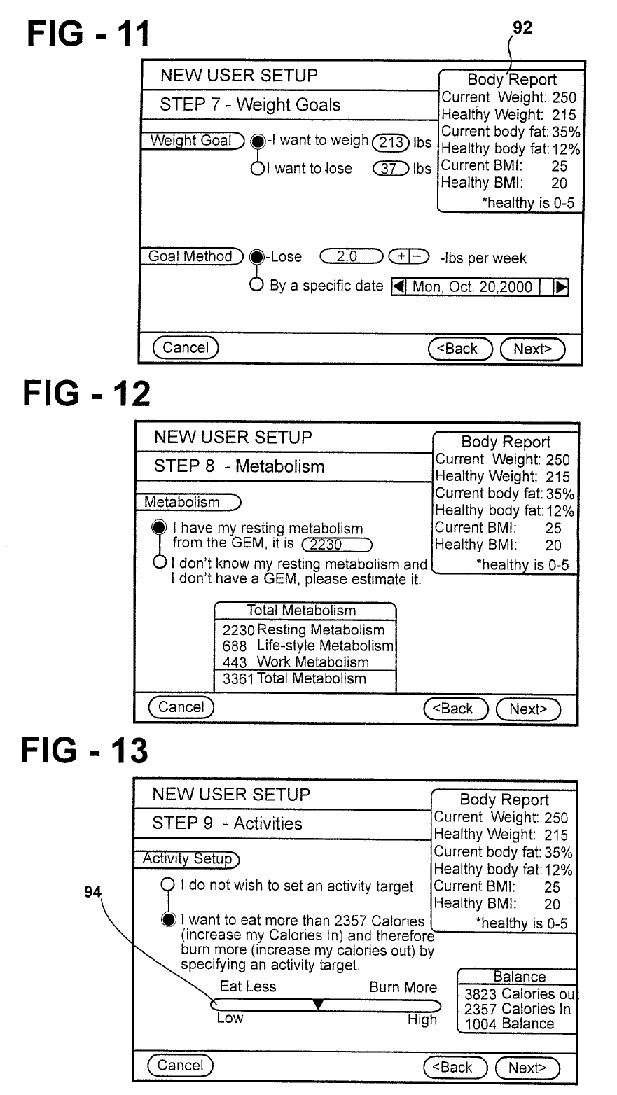

The methodology includes the step of the user selecting a predetermined health goal for the balance log. For example, as shown in FIG. 11, a screen through which the user enters his or her particular health goals on the portable device 18 is illustrated. The example described here considers the case of a user wishing to lose weight. However, other health goals may be selected, including weight gain, weight maintenance, lowering blood pressure, lowering cholesterol, managing diabetes, general conditioning, disease prevention, etc. Other goals may include reducing body fat percentage, increasing metabolic rate, reducing dietary fat, reducing other dietary components, lowering blood lipid levels, controlling blood glucose (even for non-diabetics), reducing waistline, or adjusting or controlling other health-related physiological parameters. An example of a weight goal is a final desired weight, or a desired weight loss, can be entered. A specified weight loss rate, or a date for achieving a specified weight, may also be entered as the goal.

The methodology includes the step of providing the user a summary of the information. For example, as shown in FIG. 11, a body report 92 is displayed to the user, based on entered data, showing current weight, a healthy weight, current body fat percentage, a healthy body fat percentage, a body mass index (BMI), and an accepted healthy BMI for the person. Healthy parameters are derived using equations well known in the nutritional arts.

The methodology also includes the step of the user providing their metabolic rate for the balance log, as shown in FIG. 12. In the preferred system described, the user utilizes an indirect calorimeter, for example the gas exchange monitor (GEM) as described in U.S. application Ser. No. 09/630,398, incorporated herein by reference. Other indirect calorimeters and metabolic rate meters can be used. If a metabolic rate measurement is not available, the software estimates a value, for example using the Harris-Benedict equation. Use of the Harris-Benedict equation is described by Karkanen in U.S. Pat. No. 5,839,901, incorporated herein by reference. The total metabolic rate of the user is determined from the measured or estimated resting metabolism in addition to the activity energy expenditure (AEE) associated with lifestyle and work.

The methodology further includes the step of the user providing activity data, as shown in FIG. 13. For example, the user is provided a screen on the portable device 18 through which the user enters activity data. In order to achieve a weight loss goal, caloric expenditure must exceed caloric intake. However, an activity level can be adjusted, by which the allowed caloric intake can be increased. Hence, the user enjoys the ability to eat more, by increasing the activity target to their weight loss program, and still be able to achieve weight loss goals. A qualitative analog input system, in the form of a slider control 94, is provided by which the person can indicate his or her preference for eating less or burning more calories through activity.

Activity planning may also be achieved at this stage. The user may set up a weekly activity plan to account for caloric expenditure that will be achieved through increased activity. Essentially, during the setup phase, if the user selects to have an activity target, then the methodology may display an activity planning screen under which the user can search and add activities to a specific day of the week. These activities would then also optionally be synchronized to the calendar to-do function of the computing device in order to generate alarms as reminders of planned activities or other events. Activity planning allows activities to show up on certain specified days automatically so that the user does not need to remember to search for them and log them individually. However, the user must check them off in an activity log or a monthly planner.

Preferably, the user can specify his or her preferred diet type via a screen with various diet types to select from. Various nutritional breakdowns for a specified caloric intake are known to those skilled in the nutrition art, e.g. for vegetarians, diabetics, heart patients, persons on low carbohydrate diets, and others. These are well known in the nutritional arts; for example, some aspects are discussed in U.S. Pat. No. 6,102,706 to Khoo et al.

In addition, the methodology includes the step of the user then using the balance log method for the purpose of monitoring his or her calorie management data, by tracking activity, diet, resting metabolic rate, and caloric balance. For example, the user is presented with screens to assist the user in reaching weight control goals. In some cases, the screens are divided into a number of windows, each window displaying different information or having a different functionality.

In the described example, the method is executed on a conventional personal computer, with screens viewed on a display, and data entry achieved using a conventional mouse and keyboard. Navigation between screens is achieved by mouse clicks on appropriate windows and icons, as is well known in the art. Selecting an icon or window is preferably done by clicking on the icon or window using a mouse or analogous pointing device, although other methods may be used, such as touch screens, eye tracking, voice recognition, and the like. The entry of data into a form preferably is achieved by selecting a form field, and entering the data via a keyboard. Other methods may be used as appropriate. The method can also be adapted to run on other computing devices, such as portable computing devices and personal PDA organizers. A simpler visual display may be used with devices having restricted imaging capabilities. Other data entry mechanisms may be used, such as stylus entry, touch screens, touch pads, roller-jog dials (as used on Sony PDAs), voice recognition, optical character recognition, eye-tracking, other tracking devices, thought detection, imaging, barcode scanning, and the like.

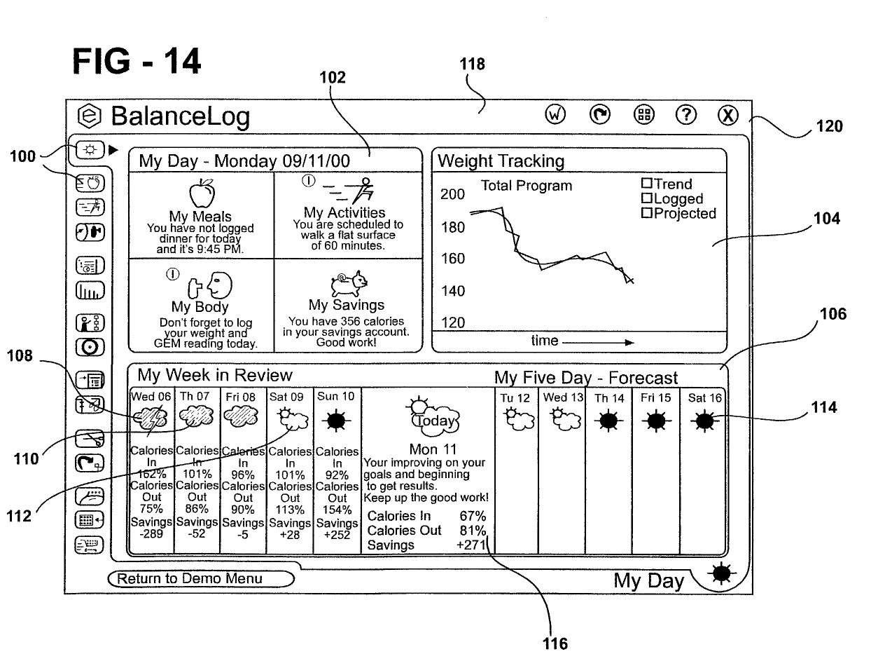

Referring to FIG. 14, one example of a screen for the step of the user using the balance log is illustrated. Icons 100 along the left edge of the screen allow the user to switch between different screens. This screen provides a central entry point into the methodology and provides immediate feedback about the program status in relation to goals. This screen can also be used to display messages announcing new versions, products, or modules. Such messages may originate from another computing device of the user, from a computer associated with a physician, dietician, fitness trainer, and the like, or may be received over a communications network from a server system. Window 102, the “My Day” window, shows summary data and allows the user to go to other screens showing information about meals, activities, physiological parameters, and a savings account in terms of calorie balance. This screen provides a home page or summary view location where important reminders, alerts, and summary information are available.

The user can view current alerts and respond to them. Typical alerts include reminding users to log his or her weight, to obtain metabolic rate measurements (for example using a GEM), reminders of scheduled activities, and whether his or her weight goals have been achieved. If the user is not achieving the weight loss goals, the method will compare the logged weight against the predicted weight and determine why the goals are not being achieved. The method can create new goals, or modify existing goals, to accommodate the user's behavior, possibly using an interactive dialog with the user.

A predicted weight for the user is determined by determining the user's calorie balance for each day, using metabolic rate measurements. If the actual logged weight of the user differs significantly from the predicted weight, this suggests that the user is either not accurately reporting food intake or caloric output levels. If the user's logged weight matches with the predicted weight, but the predicted weight is not achieving the planned weight loss goal, the software may reduce the weight loss rate goal by extending the period of the weight loss program. A counselor or dietitian may create new alerts and manage existing alerts based upon a rules engine.

Window 104 shows a graphical representation of the user's weight over time, including a projection of future weights. Window 106 provides the user with a week in review. Days on which the daily calorie balance goal is not met are represented by an icon suggestive of bad weather, such as a storm cloud 108 or a dark cloud 110. Days on which the daily calorie balance goal is attained or exceeded are represented by icons representative of good or fair weather, such as the light colored cloud 112 or a sun 114. Icons 120 near the top right of the screen allow the user to perform other operations, such as to run a set-up operation, synchronize data with another device, adjust settings, obtain help, or log out.

The bar 118 across the top of the screen is due to the use of a web browser in viewing this window, and would not be observed for the method running directly on a user's computer. However, the method may run on a remote server and be accessed using a communications network. Data may be synchronized between the server and any computing device in possession of the user before and/or after running the balance log method.

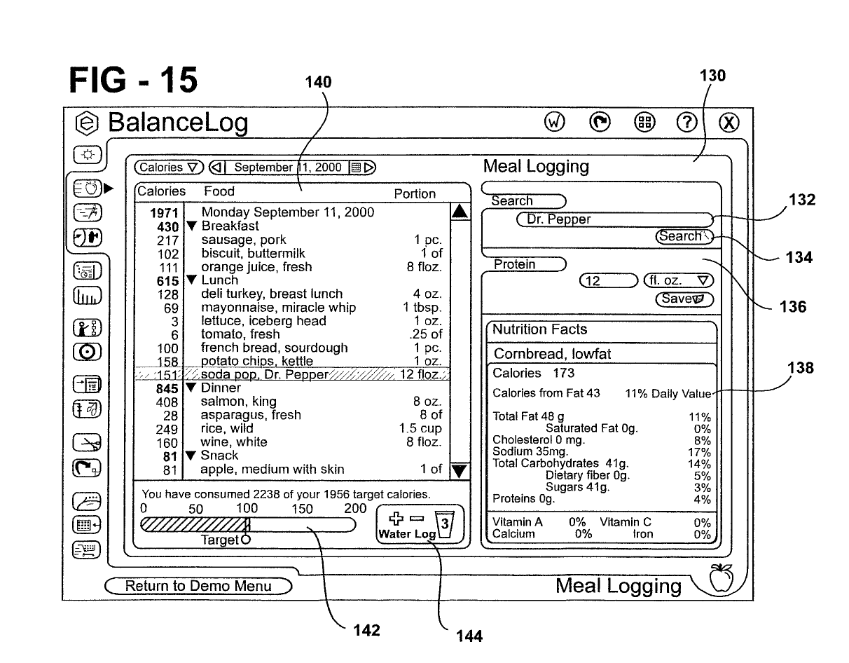

Referring to FIG. 15, another example of a screen for the step of the user using the balance log for meal logging is illustrated. The user enters the name of a food item into a search form 132 and selects the search icon 134. Food items matching the entered text are retrieved along with nutrition facts, and are displayed in window 138. The portion size can be adjusted and saved in association with the retrieved food using window 136. By searching a number of food items consumed during a meal, the user builds up a diet log of meals eaten, which is displayed in window 140. The method provides a visual indication of the progress towards calorie intake goals using a graphic display 142, and a log of water consumption using a graphic display 144.

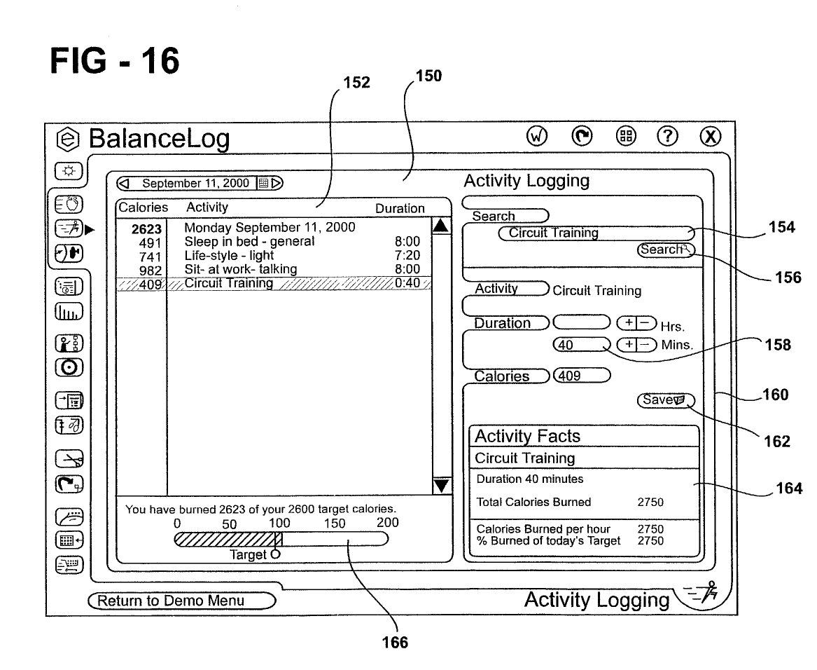

Referring to FIG. 16, still another example of a screen for the step of the user using the balance log for activity logging 150 is illustrated. The activity log is shown in window 152, and progress towards activity goals is shown using graphic display 166. The user enters an activity, such as circuit training, into a form 154, selects the search icon 156 and a duration for the activity using window 158. The calories burned for that activity may be retrieved from a database accessible by the method, or the user may enter caloric expenditure data, for example obtained from tables, equations, or an indirect calorimeter. This data is shown at 160. The user may also save caloric expenditure data associated with certain activity types. The caloric expenditure data associated with the activity is presented in window 164.

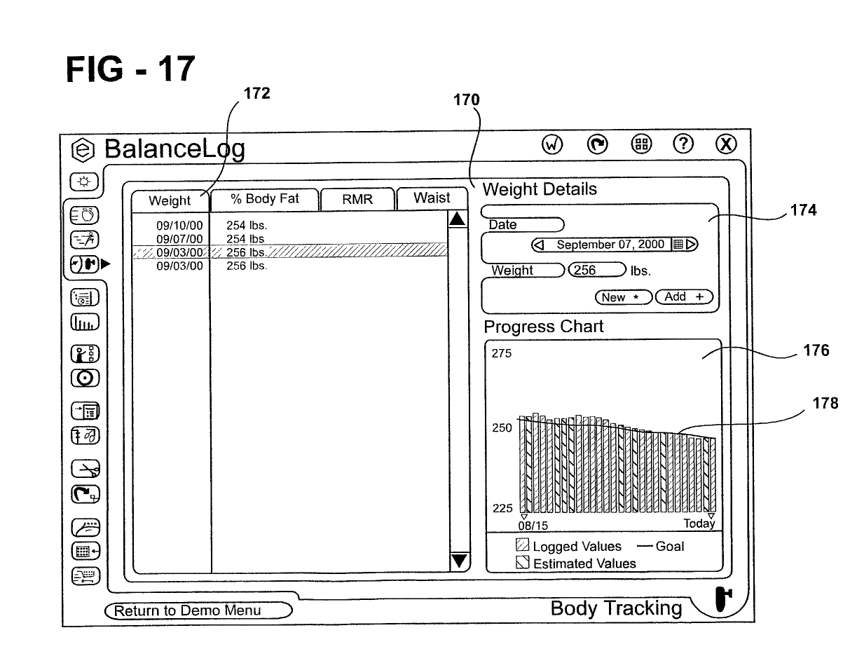

Referring to FIG. 17, yet another example of a screen for the step of the user using the balance log to display a summary of the weight details and weight progress of the user is illustrated. Window 174 allows the user to enter a date and corresponding weight. Window 176 shows a progress chart which contains both logged weights such as 180 and estimated values such as 178. Weights can be estimated from calorie balance data. Window 172 can be used to display tabular values of weight, body fat percentage, RMR, and waistline measurements over time, by selecting tabs across the top of the window 172.

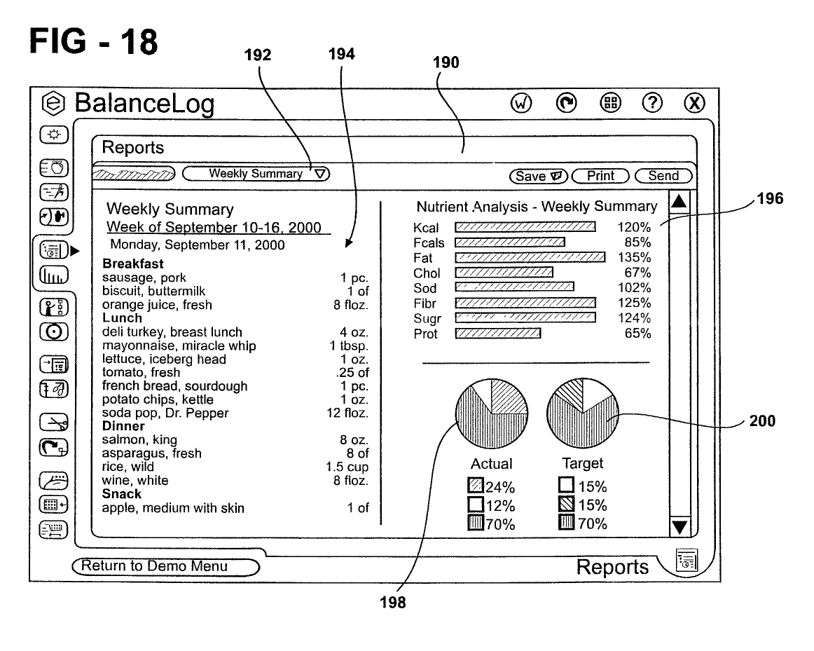

Referring to FIG. 18, still yet another example of a screen for the step of the user using the balance log to present nutrition reports to the user is illustrated. Table 194 is a weekly summary of the meals consumed by the user. Window 196 shows a nutrition analysis of the user's diet, and a comparison in terms of percentages with target goals. Pie chart 198 shows a breakdown of nutrition in terms of protein, carbohydrates and fat compared with a nutrition goal indicated by pie chart 200.

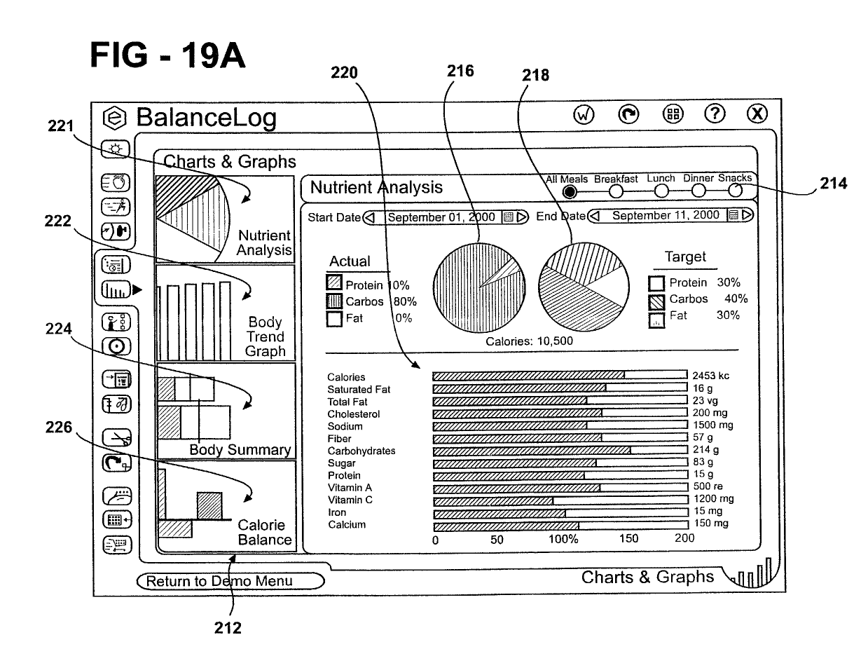

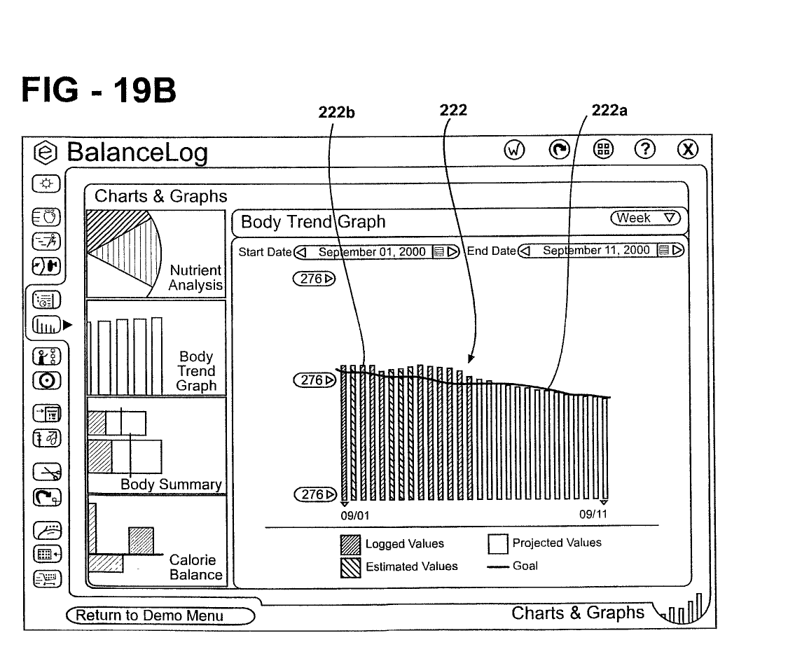

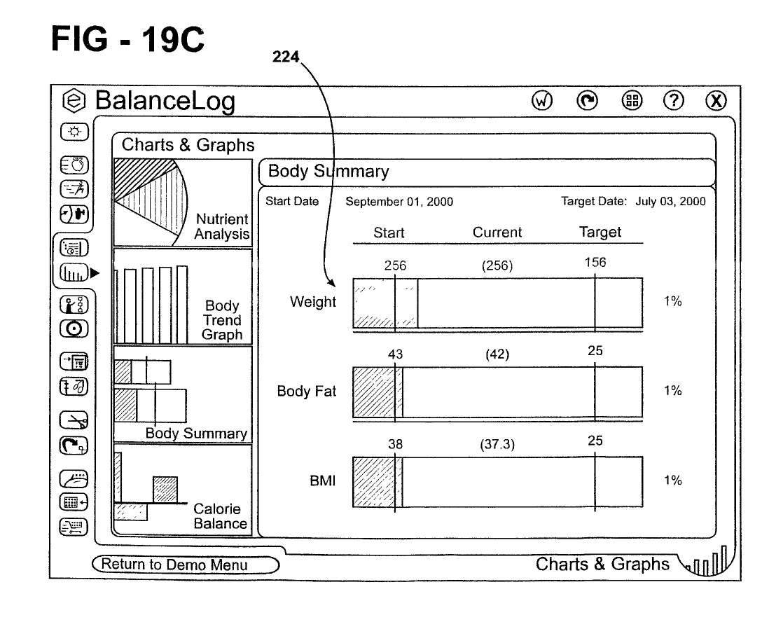

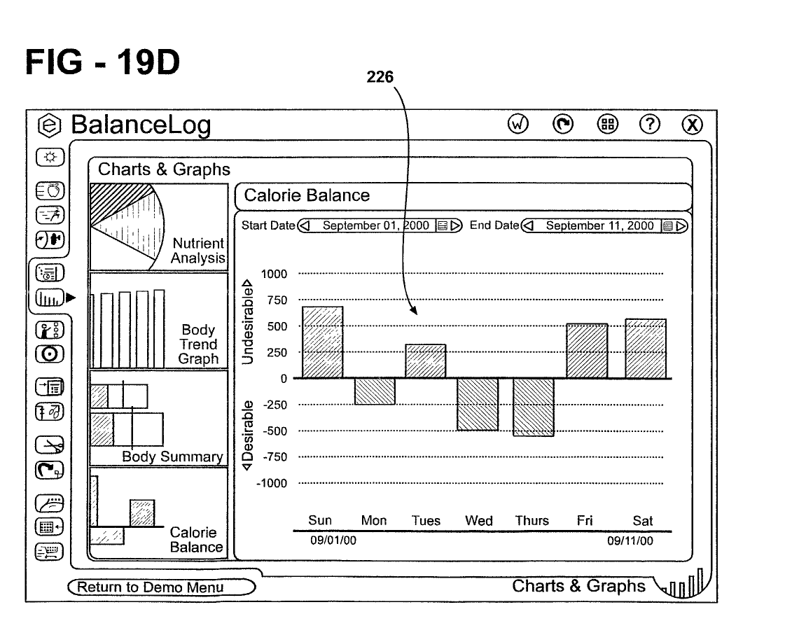

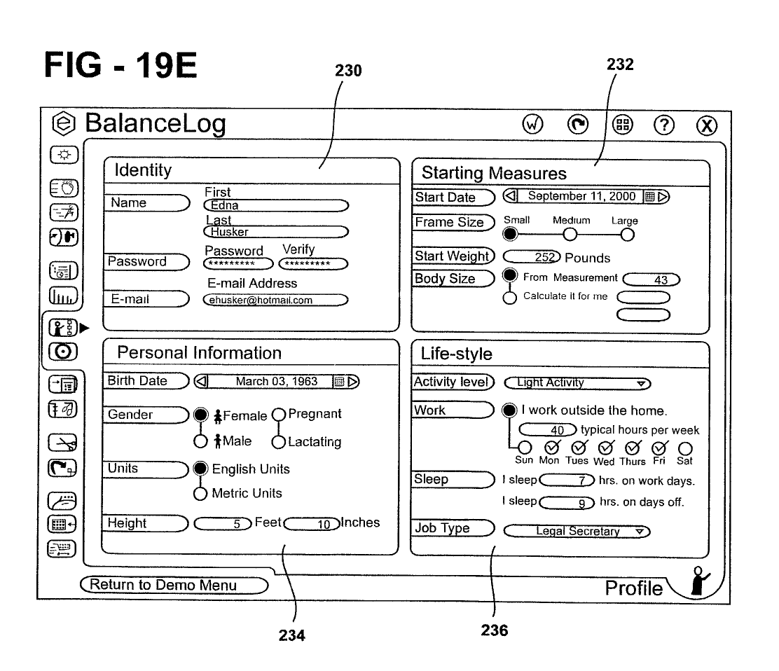

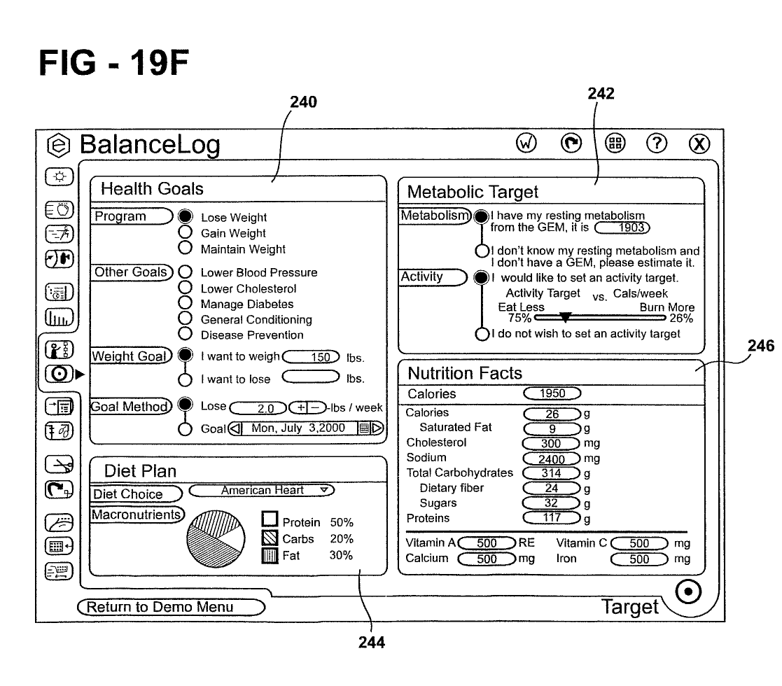

Referring to FIGS. 19A-19F, a further example of a screen illustrating the step of the user using the balance log to review weight management is provided. Preferably, the information is provided in the form of charts and graphs. In FIG. 19A, the user is provided a nutrient analysis for all meals, or for particular meals (e.g. lunches), selected using the radio button input system 214. Pie chart 216 shows an actual nutritional breakdown which is compared with the target shown on chart 218. Bar chart 220 shows a detailed nutritional breakdown of consumed food. A menu 212 is used to select between displays of nutrient analysis 221, body trend graphs 222, body summaries 224, and calorie balance 226.

In FIG. 19B, an example of a body trend graph 222 is illustrated. The weight goal is shown by a line 222a; actual recorded weights are indicated by solid bars 222b; and estimated weights are indicated by gray bars 222c. The calculation of calorie balance allows weights to be estimated, providing an advantage over conventional diet schemes.

In FIG. 19C, a body summary chart 224 is illustrated. The values of weight, body fat, and body mass index (BMI) are compared with the start values and target values, providing a visual indication of the progress towards goals. FIG. 19D shows a calorie balance chart 226, displaying the daily calorie balances.

In FIG. 19E, windows 230-236 are illustrated to display, respectively, summaries of the user's identity, starting measures, personal information, and lifestyle information. This information was entered during the set-up procedure, and may be modified using these windows.

In FIG. 19F, an example of a screen summarizing the user's goals and targets is illustrated. Window 240 shows a summary of health goals. Window 242 shows the user's metabolic rate, which may be modified using measurements from an indirect calorimeter, if available. Window 242 allows the user to modify activity targets. Window 244 indicates the diet plan that the user is following to provide a recommended balance of protein, carbohydrates, and fat. In this case, the balance of protein, carbohydrate, and fat used as a target is that suggested by the American Heart Association. Other balances are known to those skilled in the nutritional arts. Window 246 shows in tabular form the nutrient targets that the user is aiming to achieve, based on a daily caloric intake level. The method allows goals and targets to be adjusted through the course of the plan if necessary.

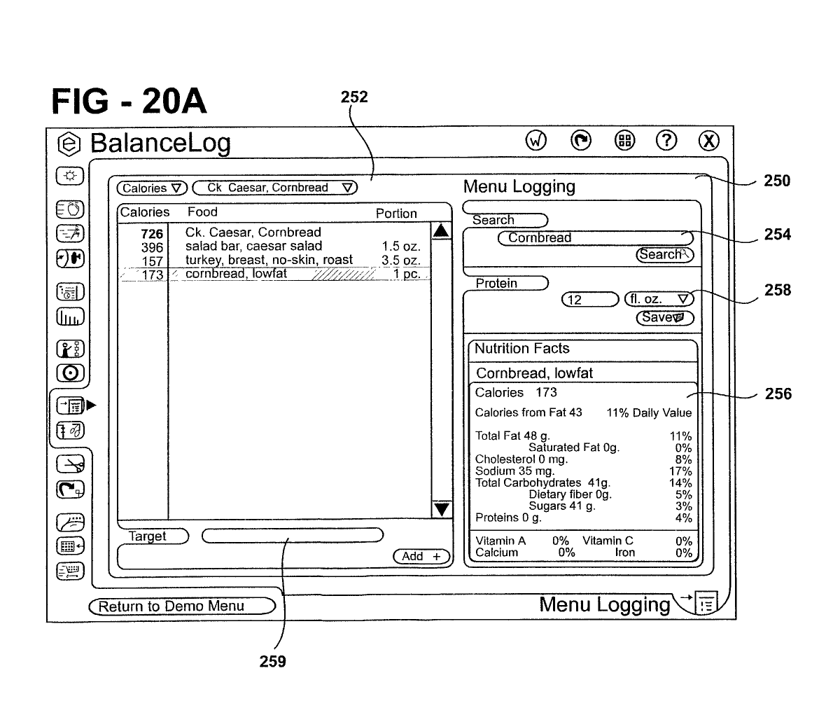

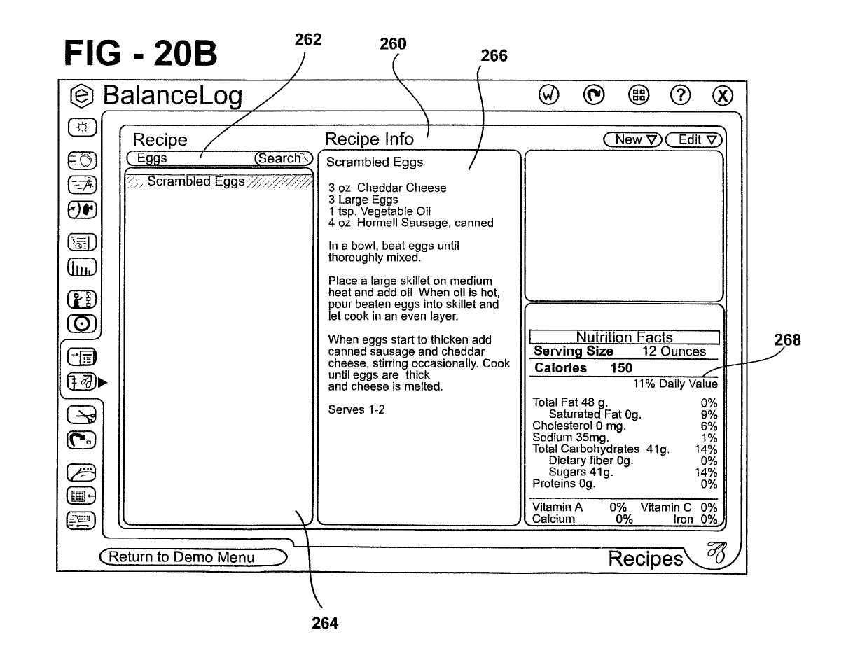

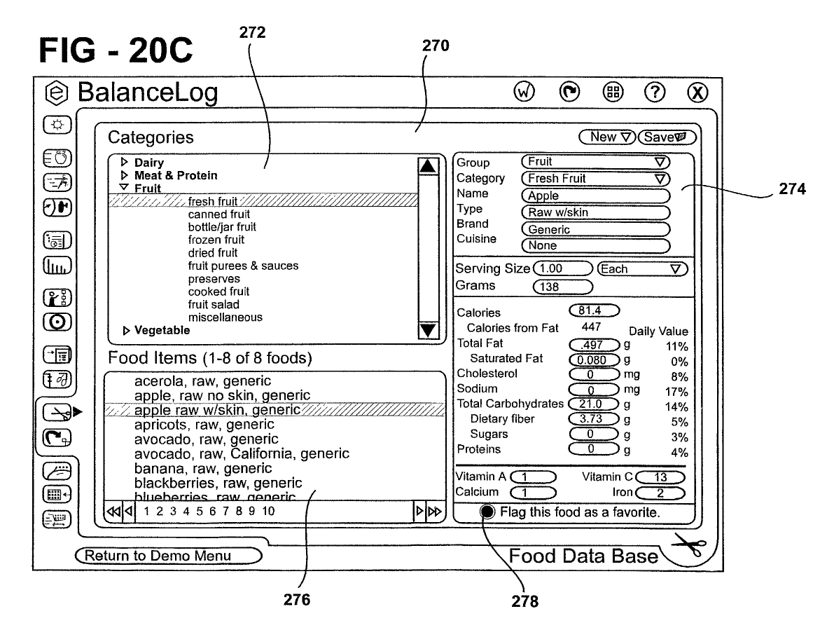

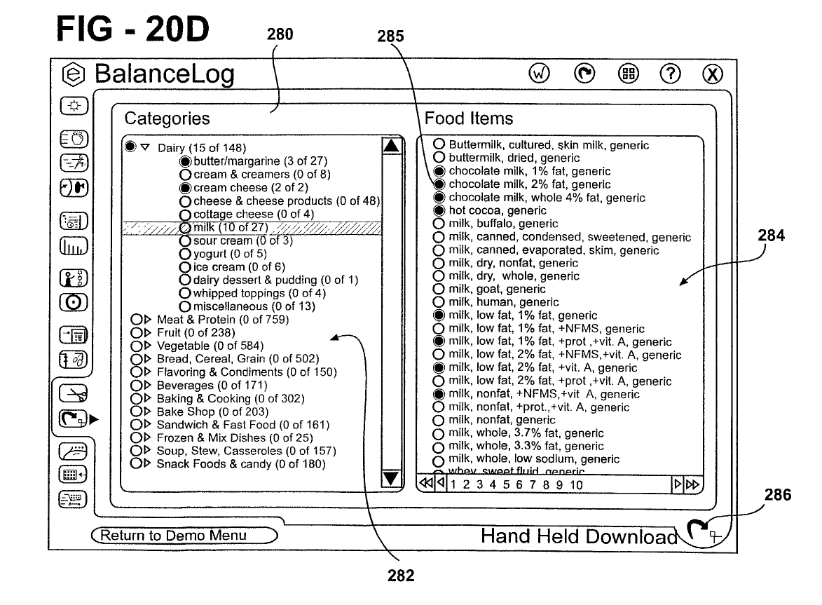

In FIG. 20A, an example of a screen illustrating the step of the user using the balance log to plan a menu is illustrated via a menu logging screen 250. The user can log foods (including beverages) consumed in the form of combinations called menu items 252. The user enters the name of a food in window 254, and initiates a search. A menu item containing the search term is displayed, and nutrition facts associated with the food are shown in window 256. The portion size can be set using window 258. This screen allows the user to enter menus, identified with a menu name, using window 259. A menu item can be a user-defined combination of existing database items, or can be provided by the software.

In FIG. 20B, another example of a screen illustrating the step of the user using the balance log to plan a menu is illustrated via a screen 260 displaying the recipe information and nutrition data associated with certain meal suggestions. The user enters the name or part of the name into window 262 and retrieves possible suggestions as listed in window 264. The recipe information related to the selected item is then displayed in window 266. Nutrition data associated with the recipe are shown in window 268.

A recipe is a collection of ingredients, having a serving size and nutritional values. Recipes may also be accompanied by preparation instructions. The user can create, modify, and consume recipes, and synchronize the data with other computing devices.

Preferably, the balance log includes a database indicating categories of food items available to the user, stored in the memory of the computing device. The method accesses the food database to present this information, as shown in FIG. 20C. Window 272 shows foods grouped by category. The user selects a category and subsequently selects a food from within that category, as listed in window 276. Nutritional information corresponding to the selected food is shown in window 274. Advantageously, the user can browse the food database, and indicate food items as favorites by selecting favorite food flag icon 278. Favorite food items are displayed near the top, or otherwise prominently, in appropriate menus. New foods can also be entered into the food database, or existing entries can be modified.

In FIG. 20D, another example of a screen 280 displaying food categories from which items can be selected is illustrated. Window 282 shows the dairy category selected, and from this category milk has been selected. Data associated with different types of milk, available to the diet log software for example through a database, are shown in window 284. The user can indicate which milk types are likely to be encountered by selecting buttons 285 along the left-hand side of window 284. For example, chocolate milk has been selected, so that chocolate milk will be shown to the person as a possible type of milk while diet logging. In contrast, buffalo milk has not been selected, so that this item may not be presented to the user during diet logging. The user selects food items expected to be encountered during a diet. The handheld download icon 286 allows the selections to be synchronized with a handheld device, such as a PDA. Hence, a PDA having restricted memory can be provided with a limited selection from the full database. A similar process may be carried out for choosing which food items are presented during diet logging using any device. In other embodiments, the full database may reside in a server system, and the user may download selected data over a communications network.

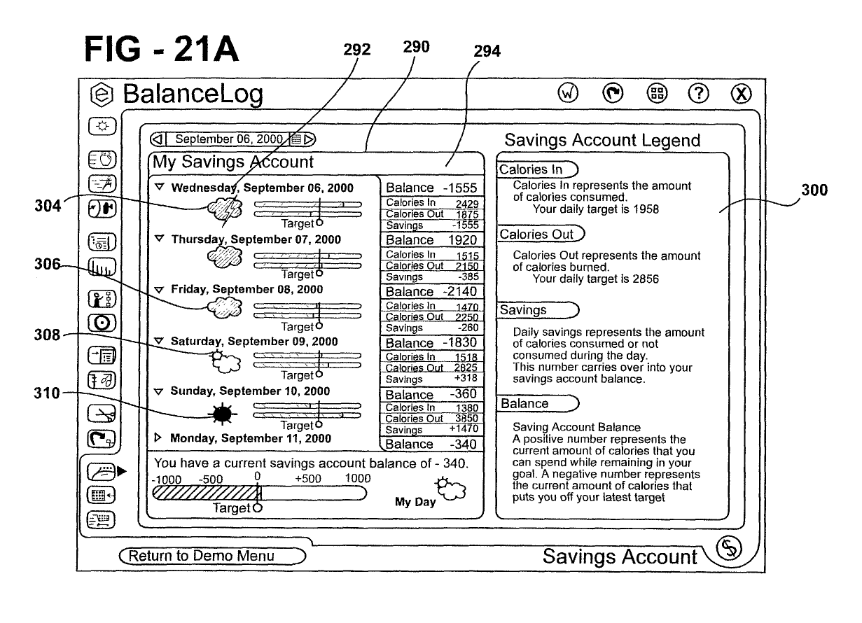

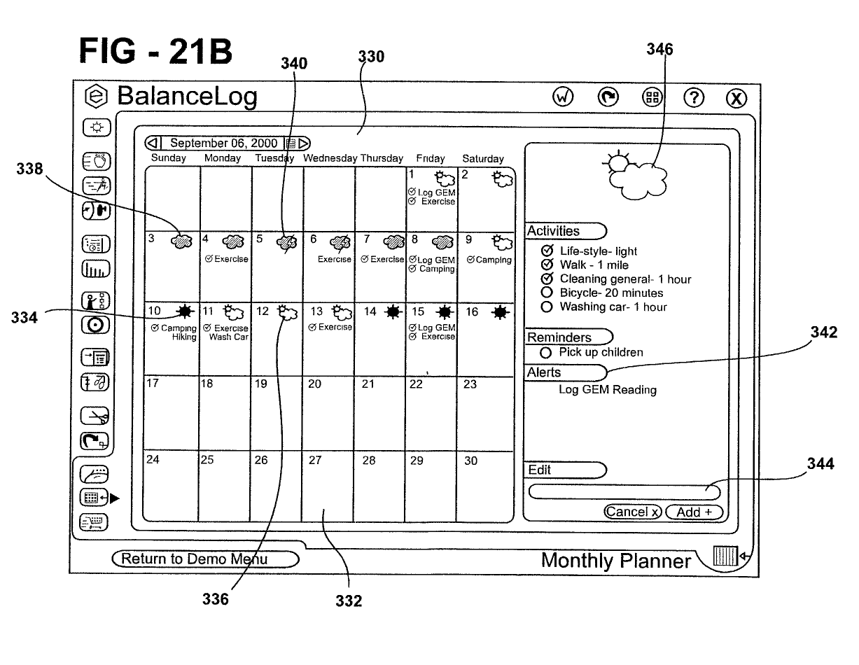

In FIG. 21, an example of a screen illustrating the step of the user receiving balance log management information for weight management is illustrated. For example, the current status of the weight loss program in terms of a savings account analogy and a weather analogy includes a display screen 290 with a window 292 showing different weather-related icons corresponding to the calorie balance on given days. For example, for days on which the daily calorie balance goal has not been reached, a bad weather icon such as storm cloud 304 or a rain cloud 306 is shown. For days on which a daily calorie balance goal has been met, an icon representative of good weather is shown, such as the broken cloud symbol 308 or sun symbol 310. Icons may be animated, for example with lightning flashes emerging from the storm cloud, and rain emerging from the rain cloud.

Numerical values of caloric intake and caloric expenditure are shown at window 294. Window 294 shows these values in the form of a savings account balance 296, representing the daily calorie difference between calories expended through resting metabolism and activity (calories out), and calories consumed through diet (calories in). The current balance log, represented in this example as a savings account balance 296 in the lower portion of window 292, shows the summation of previous daily calorie balances, and is a valuable indication to the user on the status of his or her weight loss program. Icon 298 is chosen based on the current day's calorie balance. Window 300 shows a summary of goals. The daily caloric intake is shown, along with daily caloric expenditure through activity. The daily savings represents the number of calories that the calorie balance is less than the target, and is part of the calorie savings account balance analogy shown at 296.

The savings account balance relates to the calorie balance of the user relative to goals. The system allows the user to track his or her savings account balance of calories over time. If the user consumes a number of calories less than his or her daily caloric intake target, then that number of calories is added to the savings account. Similarly, if the user bums a number of calories more than his or her caloric expenditure target, for example through additional exercise, then that number of calories is added to the savings account. However, each calorie that the user overeats or under-bums, relative to goals, is subtracted from the balance. A positive balance is good; it means that the user can forgo exercise or exceed a daily caloric intake goal.

The savings account balance captures an important principle missing from conventional diet programs, namely that targets can be missed on a daily basis, yet the diet can be a success over a longer time period. The savings account balance encourages the user to succeed in a weight loss program even if goals are not met for a day. This should reduce the attrition rate of a weight control program, the rate at which users drop out of a program. This feature can also be linked to a future reward program, for example rewards provided by a weight management business. In this case, the savings account balance is compared against the actual weight loss of the user, and calories are not retained in a user's savings account if his or her weight loss is significantly less than that predicted from the calorie balance. The comparison of the savings account balance and the actual weight can also be used to reveal diet or activity logging problems experienced by the user. The savings account balance also discourages binging after a daily goal has been missed, and encourages a sensible long-term view of weight loss.

The savings account balance is the cumulative sum of daily calorie balances. In this example, a calorie balance is positive if caloric expenditure exceeds caloric intake. Hence, if caloric intake exceeds caloric expenditure, the calorie balance is negative, the user tends to gain weight, and the savings account level becomes lower. Using the conventions described above, for a weight loss program the user will have a daily calorie balance goal that is positive. For a given day, the actual calorie balance may exceed or fall short of this goal. The calorie balance is unfavorable regarding the goal if the goal has not been reached, for example due to calorie intake being greater than planned, calorie expenditure being less than planned, or both. The calorie balance is favorable regarding the goal if the goal is reached or exceeded, in that calorie intake is less than planned, calorie expenditure is greater than planned, or both. These definitions of favorable and unfavorable are for weight loss, and the definitions are reversed for weight gain. Weight maintenance may imply a favorable range centered about a daily zero calorie balance.

Referring again to FIG. 21A, the first day shown is labeled Sept. 6. Calories in were 2430, and calories out were 1875. Hence, the net calorie intake is 555 calories, giving an actual daily calorie balance of −555 calories. The target daily calorie balance for the weight loss goal is the difference between the calorie intake target (1956) and calorie expenditure target (2956), in this case the daily calorie balance goal (or target) is 1000 calories. Hence, the user has fallen short of the goal by 1555 calories, and this number is subtracted from the savings account balance, assumed here to be previously zero. More simply, the daily savings value is (calories out−calories in−target balance), or (1875−2430−1000), giving −1555 calories.

For the next day, calories in were 1515 and calories out were 2150. This is a net expenditure of 635 calories, but is less than the goal of 1000, and so the difference (365 calories) is subtracted from the current account balance (or cumulative calorie balance), making the cumulative balance −1920 calories.

For the following day, calories in were 1470, and calories out were 2250, modifying the cumulative balance by −220 calories, resulting in a cumulative balance of −2140. The negative numbers show that the person has consumed too many calories, in relation to expended calories and target goals.

In the following day, calories in were 1515, and calories out were 2825, increasing the cumulative balance to 1830. In the following day, calories in were 1380, calories out were 3850, adding 1470 to the savings account balance, resulting in a balance of −360. The current day's cumulative balance is indicated as −340.

In this example, predetermined icons, such as weather icons 304-310 are displayed according to the daily calorie balance. For example, a storm cloud icon 304 is displayed for days where goals are missed by a large margin; a rain cloud icon 308 is displayed where goals are missed by a narrower margin; a broken cloud with sun icon 308 is displayed where the goal is missed by a narrow margin; and a sun icon 310 is displayed where the goal is missed by a wider margin. Other methods of choosing the icon to be displayed are described below.

In the above examples, storm clouds and rain clouds are used as icons representative of bad weather if targets are not met. Other icons may be used, such as icons representing tornados, hurricanes, snow, hail, ice storms, fog, rain, anvil-shaped thunder clouds, and the like. In the case where goals are met, fair weather icons are presented to the user, such as light colored clouds with a partially obscured sun, or a radiant sun. Other representations may be used, such as a plurality of fluffy clouds, stratus clouds, and the like. Icons representing the night, such as the moon, stars, and the like, may be used in place of icons representing bad weather, which contrast well with the sun containing symbols. Graphics containing the sun can be displayed for met goals, whereas graphics not containing the sun can be displayed for missed goals. In addition, an icon can be part of a more complex graphic display; for example, the sun may be combined with a representation of a bird, butterfly, flower, or other object. A goal may be considered met if it is approximately met.

It should be appreciated that the user's progress can be illustrated over a period of time, as shown in FIG. 21B. A screen 330 includes a calendar window 332. A weather related icon is shown corresponding to previous days and possibly the current day, representing the calorie balance that the user achieved on each day compared with the target goal. Good (or fair) weather icons such as 334 and 336 are shown where the daily caloric balance goal has been reached, whereas bad weather icons such as 338 and 340 are shown for days where the daily caloric balance goal has not been reached. The calendar is also used for planning activities, and can function as an organizer. Reminders for various activities related to lifestyle and exercise are shown on the window 342. The user can enter additional information through window 344. Window 342 can also show alerts, for example to encourage the user to measure his or her resting metabolic rate using an indirect calorimeter. Additional data may be entered using form 344. The status of the current or selected day can be illustrated using icon 346.

The calendar display also allows the user to view a month of planned activities, reminders, and alerts. The user can also easily check off the performed activities and reminders directly on the calendar. The calendar can synchronize with a calendar on another computing device, such as a portable computer, which can be used to provide reminders to the user, such as audible alerts, for scheduled activities.

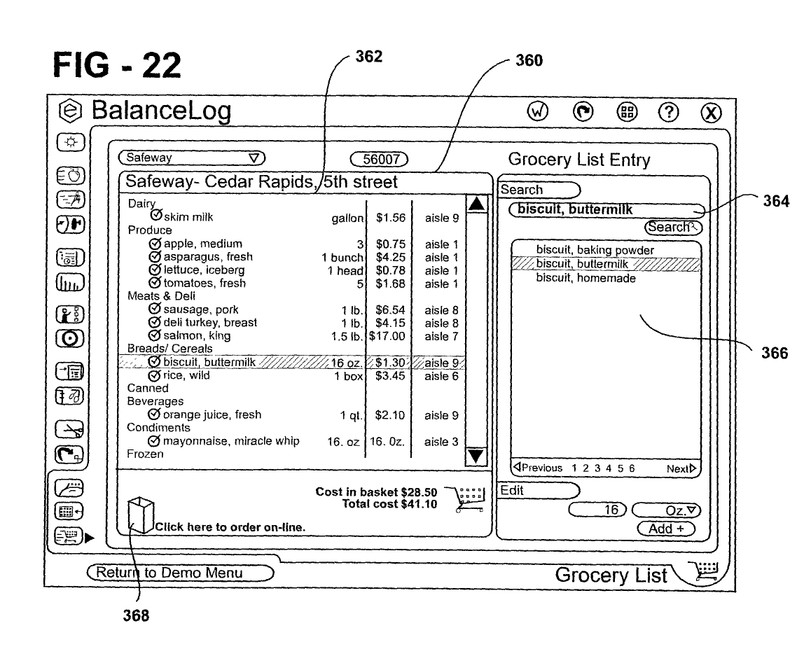

In FIG. 22, an example of a screen 360 illustrating the step of the user using the balance log in generating a shopping list to coincide with the menu previously planned. The screen 360 includes a shopping list has been generated, along with prices and aisle location for a given local grocery store. Window 362 shows a list of chosen items, along with price and aisle location within a specified grocery store. The user enters items to be purchased into window 364; retrievals from the database are shown in window 366; and the user makes selections from the presented alternatives. The option of online shopping is also presented to the user using icon 368.

Preferably, the method creates a shopping list based upon the user's menus, recipes, and needed grocery items. It can also synchronize the user's shopping list with a portable device so the list can be taken to a store. It is anticipated that prices for the chosen items are obtainable over a communications network, allowing comparisons to be made between different vendors. The method suggests items or alternatives to chosen items based on nutritional or weight control goals, or based on marketing considerations.

Other methods of food logging may also be used, including barcode scanning of packages, entering product codes, imaging of foods, and the like. The user may also define preferred defaults or abbreviated names within the software. For example, the user may define “milk” to correspond to one cup of reduced fat milk, or the abbreviation “bcc” to correspond to a bagel and cream cheese. It is anticipated that the method may also include a word recognition feature, such as found in conventional software spell checkers, to recognize mistyped names.

It is also anticipated that the food item database on the computing device may be augmented using memory modules, data received over a communication network, data received from food vendors, and the like.

Preferably, the user monitors his or her resting metabolic rate at intervals using an indirect calorimeter such as the GEM in the above-cited patent application Ser. No. 09/630,398. The method can adjust the user's targets and goals based upon changing RMR data. RMR may be determined more frequently at the onset of a weight control program, when RMR changes may be expected to be larger, and less frequently thereafter. Preferably, RMR measurements are made at least once per week. The method may also update based on an average of a previous number of GEM readings, such as four. For example, about once per month, a new goal set can be automatically created which may have a slightly different caloric intake and caloric output targets. This will help ensure better weight loss success because it will account for the change in metabolism as the user's weight or muscle mass changes. It also helps to remind users to receive a GEM measurement at least once per week.

It is contemplated that multiple users can use the same device, or that a health professional can use one device to monitor a number of users. Individual user data may be transmitted over a communications network, for access and review by a health professional. For example, authorized personnel can log in as an administrator or nutrition and fitness professional.

A client list screen provides the user with information about multiple client users. The user can view data for each of multiple clients in a group, as previously described with respect to one user. Similarly, charts and graphs are available which display various charts and graphs for an individual user, that are the same charts an individual user may view in the regular BalanceLog program.

Continuously attaining daily goals is difficult to achieve in a weight loss program. After missing one daily goal, the user may continue in failing to attain a daily goal. Advantageously, the savings account balance approach described above encourages the user to avoid behavior which widens the margin of failing to meet a goal. The user is encouraged to take a responsible attitude to missed goals, and to retain control even if a daily goal is missed. The balance log also allows the user to plan days, such as holidays, on which weight loss goals will be missed within the context of a weight loss program, something that is not always possible in a conventional weight loss scheme.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A method integrated calorie management, said method comprising the steps of:
measuring a resting metabolic rate (RM) of a user;
utilizing the measured resting metabolic rate and user activity level over a predetermined time interval to determine a total energy expenditure (TEE) of the user;
determining a total calorie intake (TCI) value representing the person's total calorie intake during the predetermined time interval;
determining from the total energy expenditure measurement and the total calorie intake value a caloric balance (CB) for the user; and
using a rate of change of the measured resting metabolic rate to determine when to remeasure the resting metabolic rate of the user.

2. A method as set forth in claim 1 wherein the rate of change of the measured resting metabolic rate varies inversely with the frequency of remeasuring the resting metabolic rate of the user.

3. The method according to claim 1, wherein the computed calorie balance is displayed for the time interval on a computing device.

4. The method according to claim 1, wherein the comparisons of the computed calorie balance to a predetermined target calorie balance is displayed for the time interval on a computing device.

5. The method according to claim 4, wherein the displayed comparisons also include a display indicating the trends of the computed calorie balances with respect to said target calorie balance.

6. The method according to claim 1, wherein the resting metabolic rate is measured by an indirect calorimeter which produces the resting metabolism measurement by analyzing the difference in the contents of the gas inhaled and exhaled by the user.

7. A method of integrated calorie management using a computing device, said method comprising the steps of:
identifying a user using the computing device;
selecting a health target for the user using the computing device;
measuring food consumption by the user during a predetermined time interval to determine a total calorie intake (TCI) of the user during the time interval by the computing device;
measuring physical activity of the user during the time interval, wherein the measured physical activity and a measured resting metabolic rate are used to determine a total energy expenditure (TEE) of the user during the time interval by the computing device;
determining from the total energy expenditure measurement and the total calorie intake value a caloric balance (CB) for the user by the computing device; and
using the caloric balance by the user to balance the user's caloric intake with the user's physical activity to meet the health target.

8. A method according to claim 7 including the step of measuring the resting metabolism (RM) of the user.

9. A method as set forth in claim 8 including the step of using a rate of change of the measured resting metabolic rate to determine when to remeasure the resting metabolic rate of the user.

10. A method according to claim 7, wherein the computed calorie balance is displayed on a computing device.

11. A method according to claim 7, wherein the comparison of the computed calorie balance to a predetermined target calorie balance is displayed on a computing device.

12. The method according to claim 11, wherein the displayed comparison also includes a display indicating a trend of the computed calorie balance with respect to said target calorie balance.

13. The method according to claim 7 wherein said resting metabolism is measured by an indirect calorimeter which determines the resting metabolic rate measurement by analyzing the difference in the contents of the gas inhaled and exhaled by the person.

14. The method according to claim 7, wherein said step of identifying the user includes providing the user's height and weight.

15. The method according to claim 7, wherein said step of providing a health target includes providing a target weight, or target nutrient goal.

16. The method according to claim 7, wherein the computing device provides information regarding targets and goals as part of a weight control program.

17. The method according to claim 7, wherein the computing device provides a nutritional value of the food intake by the user.

18. The method according to claim 7, wherein the user provides physical activity information to determine the total energy expenditure measurement.

19. The method according to claim 7, wherein the user is provided a report of progress made during the time interval towards the target weight on the computing device.

20. The method according to claim 19, wherein a level of progress made during the time interval towards the target weight is represented on the computing device by a progress-related icon.

21. A method as set forth in claim 7 including the step of graphically providing the user on a display for the computing device an indication of whether the calorie balance is progressing favorably or unfavorably towards the health target.

22. The method according to claim 21, wherein the graphical indication displayed includes a plurality of icons.

23. A system of integrated calorie management comprising:
a computer having a processor, a memory, a display and a user input mechanism;
a method of integrated calorie management stored in said memory of said computer system;
a user using the method of integrated calorie management stored in said memory of said computer system to achieve a target health goal by providing a total calorie intake (TCI) representing the user's total calorie intake during a time interval, determining by the computer a total energy expenditure (TEE) representing the total energy expenditure of the user during the time interval; determining by the computer a resting metabolic rate for the user, wherein a calorie balance (CB) value for the time interval is determined from the total energy expenditure value and the total calorie intake value; and providing on the display graphical indication of
the calorie balance for the time interval.

24. The system according to claim 23, wherein one icon is displayed if the computed calorie balance for the time interval is favorable towards achieving the target goal, and another icon is displayed if the computed calorie balance for the time interval is unfavorable towards achieving the target goal.

25. The system according to claim 23, wherein the target goal is a target weight loss over a predetermined time period.

26. A system as set forth in claim 23 including an activity monitor adapted to provide a signal correlated to the physical activity of the person to the computer.

27. A system as set forth in claim 23 including an indirect calorimeter to measure the resting metabolic rate of the user.

28. A system as set forth in claim 23 wherein the computer is a handheld PDA.

29. A method of integrated calorie management using a computing device, said method comprising the steps of:
identifying a user using the computing device;
selecting a health target for the user using the computing device;
providing measured food consumption during a predetermined time interval by the user to the computing device;
using the food consumption by the computing device to determine a total calorie intake (TCI) of the user during the time interval;
providing measured physical activity of the user during the time interval to the computing device,
using by the computing device the measured physical activity and a measured resting metabolic rate to determine a total energy expenditure (TEE) of the user during the time interval;
determining by the computing device a caloric balance for the user during the time interval from the total energy expenditure measurement and the total calorie intake; and
maintaining the calorie balance for the time interval in a balance log stored in a memory of the computing device; and
using the balance log by the user with the health target.
